(19) United States
(12) Patent Application Publication
(10) Pub. No.: US 2026/0319096 A1
(43) Pub. Date: Oct. 15, 2026

(54) VISION-GUIDED MIMO RADAR BEAMFORMING SYSTEM AND CALIBRATION METHOD

(71) Applicant: Arizona Board of Regents on behalf of Arizona State University, Scottsdale, AZ (US)

(72) Inventors: Yu Rong, Tempe, AZ (US); Shuaifeng Jiang, Tempe, AZ (US); Ahmed Alkhateeb, Chandler, AZ (US); Daniel W. Bliss, Phoenix, AZ (US)

(21) Appl. No.: 19/481,102

(22) PCT Filed: May 6, 2024
(86) PCT No.: PCT/US2024/027993

§ 371 Date: Nov. 3, 2025

Related U.S. Application Data
(60) Provisional application No. 63/500,430, filed on May 5, 2023.

(51) Int. Cl. G01S 17/89; G01S 7/48; G01S 17/86

(52) U.S. Cl. CPC G01S 17/89; G01S 7/4802; G01S 17/86

(57) ABSTRACT

A vision-guided radar beamforming system and method for calibrating such a system include a camera-radar dual sensing apparatus having an array of radar transmitters, an array of radar receivers, and at least one optical camera configured to provide depth information. A memory contains a transformation function that maps visual coordinates to radar coordinates within a field of view of the dual sensing apparatus, optionally modeled with an affine transformation usable to describe translation, reflection, rotation, and scaling transformations. A corner reflector sequentially placed at multiple positioned within the field of view may be used to collect radar and visual coordinates used for generating the transformation function.

### CROSS-REFERENCE TO RELATED APPLICATION(S)

This application claims priority to U.S. Provisional Patent Application No. 63/500,430 filed on May 5, 2023, wherein the entire contents of the foregoing application are hereby incorporated by reference herein.

### BACKGROUND

Vital signs, such as heart and respiratory rates, provide critical insight into a person's well-being. Traditional methods of vital sign monitoring involve inconvenient and uncomfortable wearable devices. To capture both heart and respiratory rates, two different sensors are required, e.g., a multi-led electrocardiography sensor which measures the heart's electrical activity and a chest respiration belt which measures the air pressure variation according to the breathing of the subject. These standard monitoring wearables can typically measure a single object and do not apply to multi-subject scenarios. More convenient means of non-contact monitoring are then required to address these needs. Recent developments have successfully demonstrated radar technologies using single-device sensors for this purpose [1].

There are two major competing remote sensing technologies for physiological parameter estimation: vision-based approaches and wireless based approaches. A regular red, green and blue (RGB) camera can capture the color shift on the exposed facial skins under proper lighting conditions and the blood flow induced skin color tone change is used to extract blood pulse flow. The imaging based technology is often referred to as remote imaging plethysmography (RPPG) [2]. The distinct drawback of using color cameras is the privacy issue. Thus, near-infrared (NIR) camera sensing was investigated heavily based on the same RPPG principle for heart analysis because of the alleviated privacy concern and immunity of ambiance lighting change [3]. However, the heartbeat pulse sensitivity at IR wavelengths is significantly weaker compared to that of visible light (often green light) using RGB cameras. More recently, state-of-the-art cameras based on time-of-flight (ToF) technology measure precise depth for respiratory monitoring via active IR projection to perceive depth [4]. Using the depth measurements, the improved respiratory signal quality is observed from the depth pixel intensity change at area compared to the color pixel intensity change [5].

Radar is another promising technology for remote health monitoring. It enjoys all-weather features and raises no privacy issues compared to the vision counterpart. One unique advantage exists in radar is excellent material penetration capability, such as through clothes and bedding, wherein this penetration capability is a desirable feature in daily health monitoring and patient care. Radar echoes capture rich information of human body activity and inner organ movements. Physiological motion often shows repetitive yet time-varying patterns. The coherent transceiver in the radar system measures these minute motions based on the well-known micro-Doppler effect [6]. Various types of radar systems were used to detect chest wall motion due to respiratory and cardiac activities. Continuous-wave (CW) radars measure micromotion assuming no other sources of motion interference. When there are multiple sources of motion and/or multiple subjects, however, the performance of these narrow-band systems degrades [7], [8]. Wideband radar systems, such as impulse ultra-wideband (UWB), frequency-modulated-CW (FMCW), and stepped-frequency-CW (SFCW), are able to distinguish targets at different ranges, but struggle to provide spatial positioning. Despite beneficial features such as motion sensitivity, privacy preservation, and penetrability, radar has limited spatial degrees of freedom compared to optical sensors, and this makes it challenging for radar to sense crowded environments without prior information. Utilizing an array of antennas provides increased degrees of freedom (DoF) compared to single-antenna systems [9]. This allows targets to be distinguished in both spatial angle and range. Advanced array processing techniques are available to boost radar sensing and imaging performance [10]-[13]. Recently, the use of millimeter-wave (mmWave) and sub-terahertz (THz) frequency bands has gained popularity in remote vital signs monitoring [14]-[16]. With smaller wavelength, radar systems can be packed into a small form factor equipped with more antennas.

Sensor fusion concept for improved vital signs (VSD) has been exploited in [17] by using a cellphone camera and CW radar to cancel random body motion. The cellphone camera was used to record large-scale body motions. The authors of such prior work formulated a dual channel blind source separation problem.

Recently, a thermal camera and two independent CW radars (2.4 GHz) were used together in [18] for measuring vitals from multiple subjects. In their setup, the thermal camera only provided spatial identification and no depth information. Since the coordinates cannot be fused directly with the two non-coherent CW radar, lengthy signal processing was required to combine signals from the thermal camera and the two CW radars. The two independent radars were used only to expand radar coverage in azimuth and also create two independent channels with spatial diversity.

A novel camera and radar fusion concept was presented in [19]. The system according to such work was constructed in a more natural way based on coordinate mapping. The setup included a three-dimensional (3-D) depth camera to provide precise 3-D coordinates as a vision guidance and a mmWave multiple-input multiple-output (MIMO) to perform beamforming (BF) given the vision guidance. Critical Information about vision coordinate and radar coordinate mapping performance was not given. But the subsequent sensing performance is directly related to the coordinate mapping accuracy. More importantly, the full potential of vision guided radar for VSD has not been conveyed. Due to the limited array size, eight effective elements horizontally and two elements vertically, two human subjects with a minimum of 20 centimeters were demonstrated for VSD while prior works using similar mmWave radar without camera [14], [20], [21] reported success in separating two human subjects and estimating each subject's heart rate (HR) and respiratory rate (RR).

### SUMMARY

A vision-guided radar beamforming system and method for calibrating such a system includes a camera-radar dual sensing apparatus having an array of radar transmitters, an array of radar receivers, and at least one optical camera configured to provide depth information. The foregoing items may be positionally fixed with a support structure. Vision coordinates and radar coordinates are mapped to one another. A memory contains a transformation function that maps visual coordinates to radar coordinates within a field of view (FOV) of the camera-radar dual sensing apparatus, with the apparatus being configured to utilize the transformation function for vision-guided radar beamforming. In one embodiment, the transformation between the two coordinate systems can be modeled by an affine transformation, which can be used to describe translation, reflection, rotation, and scaling transformations.

In one aspect, the disclosure relates to a method for using a vision-guided radar beamforming system. Such method comprises: positionally fixing, with a support structure, an array of radar transmitters, an array of radar receivers, and at least one optical camera configured to provide depth information to provide a camera-radar dual sensing apparatus; sequentially placing a corner reflector at a plurality of positions within a field of view (FOV) of the camera-radar dual sensing apparatus; operating the array of radar transmitters, the array of radar receivers, and the at least one optical camera while the corner reflector is placed at each of the plurality of positions within the FOV; collecting, with the array of radar receivers, radar coordinates corresponding to a peak locations of an energy cluster of radar energy reflected by the corner reflector, while the corner reflector is placed at each of the plurality of positions within the FOV; collecting, with the at least one camera, visual coordinates of a reflective center of the corner reflector, while the corner reflector is placed at each of the plurality of positions within the FOV; and utilizing a computing device employing the collected radar coordinates and the collected visual coordinates, to generate a transformation function that maps visual coordinates to radar coordinates within the FOV of the camera-radar dual sensing apparatus.

In certain embodiments, the transformation function comprises an affine transformation with twelve degrees of freedom that incorporate three-dimensional translation and rotation.

In certain embodiments, the method further comprises constructing radar beamforming weights utilizing coefficients of the affine transformation.

In certain embodiments, the method further comprises operating the camera-radar dual sensing apparatus to detect at least one of: presence of one or more human subjects in the FOV, and vital signs of one or more human subjects in the FOV.

In certain embodiments, the vital signs comprise respiration rate and/or heart rate.

In certain embodiments, the at least one optical camera comprises a plurality of optical cameras.

In certain embodiments, the array of radar transmitters comprises a linear array of radar transmitters, the array of radar receivers comprises a linear array of radar receivers, and the linear array of radar transmitters is arranged orthogonal to the linear array of radar receivers.

In another aspect, the disclosure relates to a vision-guided radar system comprising: a camera-radar dual sensing apparatus including an array of radar transmitters, an array of radar receivers, and at least one optical camera configured to provide depth information; and a memory containing a transformation function that maps visual coordinates to radar coordinates within a field of view (FOV) of the camera-radar dual sensing apparatus; wherein the camera-radar dual sensing apparatus is configured to utilize the transformation function for vision-guided radar beamforming in use of the camera-radar dual sensing apparatus.

In certain embodiments, the system further comprises a support structure that positionally fixes the array of radar transmitters, the array of radar receivers, and the at least one optical camera relative to one another.

In certain embodiments, the system further comprises a computing device configured to employ collected radar coordinates and collected visual coordinates to generate the transformation function.

In certain embodiments, the collected radar coordinates are obtained by collecting, with the array of radar receivers, radar coordinates corresponding to a peak locations of an energy cluster of radar energy reflected by a corner reflector, while the corner reflector is sequentially placed at each of a plurality of positions within the FOV; and the collected visual coordinates are obtained by collecting, with the at least one camera, visual coordinates of a reflective center of the corner reflector, while the corner reflector is sequentially placed at each of the plurality of positions within the FOV.

In certain embodiments, the transformation function comprises an affine transformation with twelve degrees of freedom that incorporate three-dimensional translation and rotation.

In certain embodiments, the utilization of the transformation function comprises utilization of coefficients of the affine transformation.

In certain embodiments, the system is configured to detect at least one of: presence of one or more human subjects in the FOV, and vital signs of one or more human subjects in the FOV.

In certain embodiments, the vital signs comprise at least one of respiration rate and heart rate.

In certain embodiments, the at least one optical camera comprises an RGB camera and a depth sensor.

In certain embodiments, the array of radar transmitters comprises a linear array of radar transmitters, the array of radar receivers comprises a linear array of radar receivers, and the linear array of radar transmitters is arranged orthogonal to the linear array of radar receivers.

In another aspect, any two or more features of the foregoing aspects and/or features disclosed herein may be combined for additional advantage.

### BRIEF DESCRIPTION OF DRAWINGS

The accompanying drawing figures incorporated in and forming a part of this specification illustrate several aspects of the disclosure, and together with the description serve to explain the principles of the disclosure.

FIG. 1 is a schematic diagram showing elements of a vision guided radar system according to one embodiment, including a dual sensing apparatus having an optical camera configured to identify body landmarks of multiple subjects and a multiple input, multiple output (MIMO) radar device, with the system configured to utilize a transformation function obtained by mapping of camera coordinates to radar coordinates within the FOV of the dual sensing system to enable high precision guided beamforming of the MIMO radar device.

FIGS. 2A.1, 2A.2, and 2A.3 provide a black and white traced RGB image (i.e., a black and white drawing derived from a color RBG image), a black and white traced depth image, and a radar image, respectively, of a corner reflector arranged within a field of view of a camera-radar dual sensing apparatus).

FIGS. 2B.1, 2B.2, and 2B.3 provide a black and white traced RGB image, a black and white traced depth image, and a radar image, respectively, of a single human subject arranged within a field of view of the camera-radar dual sensing apparatus, with human body landmarks highlighted in the RGB image of FIG. 2B.1.

FIGS. 2C.1, 2C.2, and 2C.3 provide a black and white traced RGB image, a black and white traced depth image, and a radar image, respectively, of three human subjects arranged within a field of view of the camera-radar dual sensing apparatus, with human body landmarks highlighted in the RGB image of FIG. 2C.1.

FIGS. 3A.1, 3A.2, and 3A.3 each provide one black and white traced depth imaging snapshot of three human subjects in a FOV of a camera-radar dual sensing apparatus from a five-second-long dataset.

FIGS. 3B.1, 3B.2, and 3B.3 each provide one radar imaging snapshot of three human subjects in a FOV of a camera-radar dual sensing apparatus from a five-second-long dataset, exhibiting greater variation between frames than in FIGS. 3A.1, 3A.2, and 3A.3.

FIGS. 4A.1 and 4A.2 provide front and rear views, respectively, of a MIMO imaging radar device useable with embodiments according to the present disclosure.

FIG. 4B is a plot of frequency versus time of a stepped-frequency continuous-wave (SFCW) signaling scheme implemented with a time division multiplexing MIMO configuration useable with embodiments according to the present disclosure.

FIG. 4C schematically illustrates a transmitter antenna array, a receive antenna array, and a MIMO virtual array obtained by convolution of transmitter and receiver aperture functions.

FIG. 4D provides a radar imaging example of a human subject using a camera-radar dual sensing apparatus system according to one embodiment of the present disclosure.

FIG. 5 illustrates use of a checkerboard with four vertices labeled to evaluate the depth point cloud accuracy in x/y-axis.

FIG. 6 shows components of a vision-guided radar system including camera-radar dual sensing apparatus having an array of radar transmitters, an array of radar receivers, and at least one optical camera configured to provide depth information all positionally fixed with a support structure, and further showing a corner reflector arranged in field of view of the dual sensing apparatus.

FIG. 7A includes an upper frame embodying a black and white traced RGB image with torso landmarks, and includes a lower frame embodying a black and white traced depth image, for a first experiment scene including a single human subject.

FIG. 7B includes an upper frame embodying a black and white traced RGB image with torso landmarks, and includes a lower frame embodying a black and white traced depth image, for a second experiment scene including two human subjects.

FIG. 7C includes an upper frame embodying a black and white traced RGB image with torso landmarks, and includes a lower frame embodying a black and white traced depth image, for a third experiment scene including a group of four human subjects.

FIGS. 8A.1, 8A.2, and 8A.3 provide range profiles (relative magnitude versus range) obtained using a vision-guided radar system as disclosed herein and processed according to three different processing techniques, namely: single channel, non-coherent combining of all channels, and coherent combining, respectively.

FIGS. 8B.1, 8B.2, and 8B.3 provide respiration patterns (displacement versus time) obtained from the range profiles of FIGS. 8A.1, 8A.2, and 8A.3 and processed with three different processing techniques, namely: single channel, non-coherent combining of all channels, and coherent combining, respectively.

FIGS. 8C.1, 8C.2, and 8C.3 provide phase signals (quadrature versus in-phase) obtained from the respiration patterns of FIGS. 8B.1, 8B.2, and 8B.3 and processed with three different processing techniques, namely: single channel, non-coherent combining of all channels, and coherent combining, respectively.

FIG. 9A.1 provides estimated respiration pattern (displacement versus time) and FIG. 9A.2 provides vital signs spectrum (relative spectral power versus BPM, with a superimposed dashed blue and red lines representing breathing rate and heart rate derived from a breathing belt and an oximeter) obtained from the standing subject of the experiment characterized in FIG. 7B.

FIG. 9B.1 provides estimated respiration pattern (displacement versus time) and FIG. 9B.2 provides vital signs spectrum (relative spectral power versus BPM, with a superimposed dashed blue and red lines representing breathing rate and heart rate derived from a breathing belt and an oximeter) obtained from the seated standing subject of the experiment characterized in FIG. 7B.

FIG. 10A provides a first range-time heatmap (represented in dB power) of all four subjects for the experiment characterized in FIG. 7C, utilizing single channel processing.

FIG. 10B provides a second range-time heatmap (represented in dB power) of all four subjects for the experiment characterized in FIG. 7C, processed by non-coherent combining of all channels.

FIGS. 10C.1 to 10C.4 provide separate range-time heatmaps for the four human subjects of the experiment characterized in FIG. 7C with vision aided beamforming for separating the four human subjects.

FIG. 11A.1 provides estimated respiration pattern (displacement versus time) and FIG. 11A.2 provides vital signs spectrum (relative spectral power versus BPM, with a superimposed dashed blue and red lines representing breathing rate and heart rate derived from a breathing belt and an oximeter) obtained from the lower-left human subject of the experiment characterized in FIG. 7C.

FIG. 11B.1 provides estimated respiration pattern (displacement versus time) and FIG. 11B.2 provides vital signs spectrum (relative spectral power versus BPM, with a superimposed dashed blue and red lines representing breathing rate and heart rate derived from a breathing belt and an oximeter) obtained from the lower-right human subject of the experiment characterized in FIG. 7C.

FIG. 11C.1 provides estimated respiration pattern (displacement versus time) and FIG. 11C.2 provides vital signs spectrum (relative spectral power versus BPM, with a superimposed dashed blue and red lines representing breathing rate and heart rate derived from a breathing belt and an oximeter) obtained from the top-left human subject of the experiment characterized in FIG. 7C.

FIG. 11D.1 provides estimated respiration pattern (displacement versus time) and FIG. 11D.2 provides vital signs spectrum (relative spectral power versus BPM, with a superimposed dashed blue and red lines representing breathing rate and heart rate derived from a breathing belt and an oximeter) obtained from the top-right human subject of the experiment characterized in FIG. 7C.

FIG. 12 embodies Table I identifying notation (i.e., descriptions for variables) adopted in this disclosure.

FIG. 13 embodies Table II identifying 3-D camera system parameters (including camera system configuration and point cloud accuracy) for the 3-D camera portion of the camera-radar dual sensing apparatus utilized in experiments described herein.

FIG. 14 embodies Table III identifying 3-D mmWave imaging radar parameters (including radar configuration and radar resolution at 0.5 meter boresight) for the radar portion of the camera-radar dual sensing apparatus utilized in experiments described herein.

FIG. 15 embodies Table IV identifying camera-radar alignment mean absolute error obtained on training and test datasets for experiments described herein.

FIG. 16 embodies Table V comparing an embodiment described herein to methods already known in the art.

FIG. 17 is a block diagram of a computer system suitable for calibrating and/or operating a camera-radar dual sensing apparatus according to embodiments disclosed herein.

### DETAILED DESCRIPTION

Systems and methods disclosed herein permit accurate and automatic localization of human subjects in an environment and estimation of vital signs parameters from each human subject.

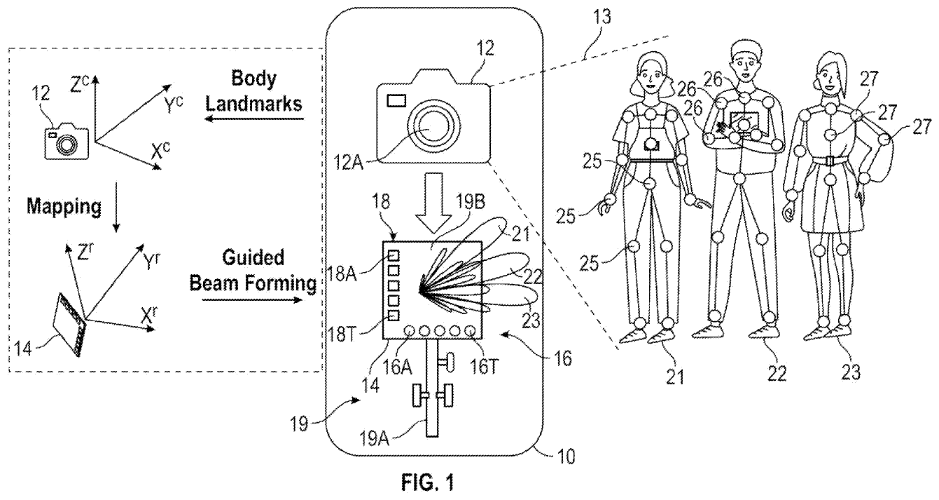

Vision-guided MIMO radar beamforming for vital signs detection in a complex environment according to one embodiment is shown in FIG. 1. A camera-radar dual sensing apparatus 10 includes an optical camera 12 with 3-D depth sensing capability (e.g., the optical camera may include an RGB camera with a depth sensor) and a low-power millimeter wave (mmWave) radar device 14 including a multi-static MIMO array having twenty transmit antennas (Tx) 16A-16T (in Tx array 16) by twenty receive antennas (Rx) 18A-18T (in Rx array 18) to form a total of 400 virtual array elements. Multiple (human) subjects 21-23 may be arranged in field of view (FOV) 13 of the optical camera 12, with the optical 12 camera being configured to identify body landmarks 25-27 of the subjects 21-23.

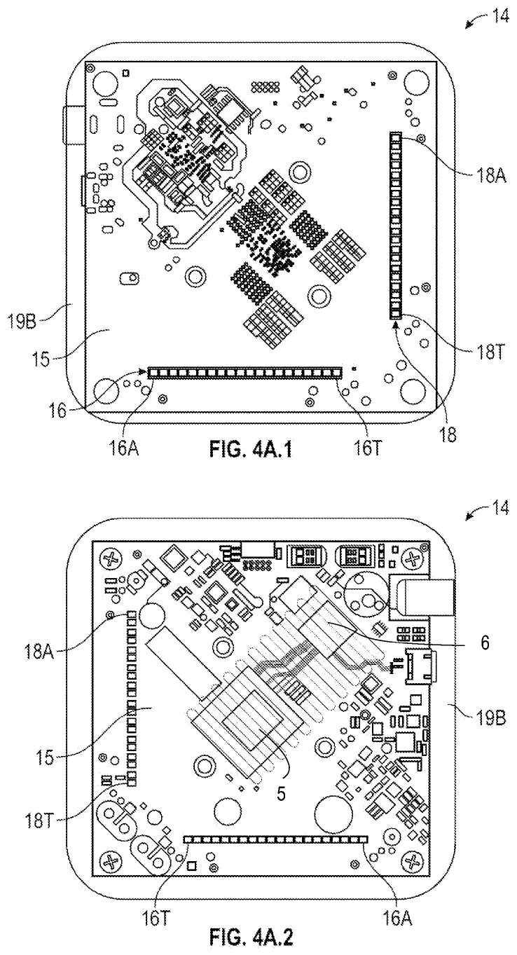

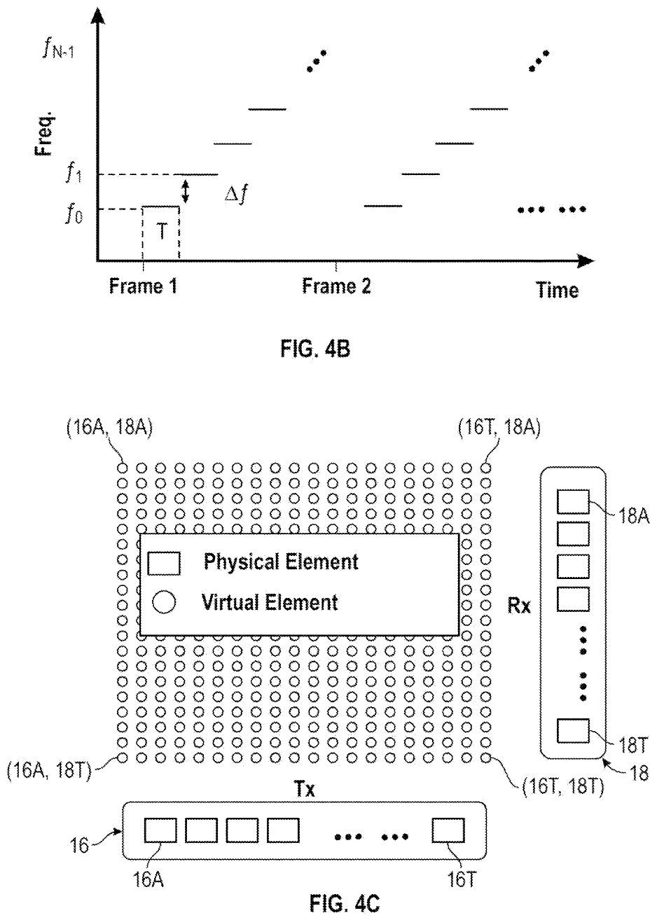

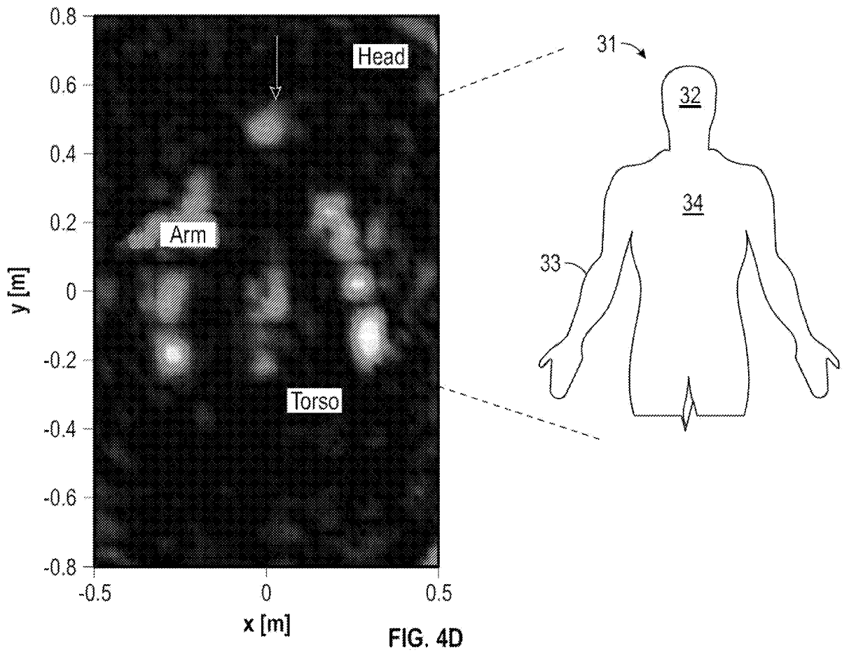

The Tx and Rx antennas 16A-16T, 18A-18T as well as the optical camera 12 (with depth sensing capability) are positionally fixed relative to one another using a support structure 19. In certain embodiments, a support structure 19 may include a tripod 19A with clamps or other mounting elements. In certain embodiments, a support structure 19 may embody a body structure 19B (e.g., a substrate) incorporating the optical camera 12 as well as the Tx and Rx antennas 16, 18 of the radar device 14, optionally supported by a tripod 19A. Optionally, the Tx and Rx antennas 16, 18 may be arranged on a circuit board (e.g., as shown in FIGS. 4A.1-4A.2) to which a processor and memory are also mounted. The Tx and Rx arrays 16, 18 should be arranged non-parallel to one another. In certain embodiments, a Tx array 16 may include individual transmitters 16A-16T arranged in a horizontal line and a Rx array 18 may include individual receivers 18A-18T arranged in a vertical line, or vice-versa. Numerous positional variations may be employed to form virtual array elements arranged in a two-dimensional configuration, so long as the Tx and Rx arrays 16, 18 are not arranged parallel to one another. The leftmost frame of FIG. 1 (within dashed lines) schematically shows that body landmarks are captured by the camera 12, that mapping data (by which vision coordinates and radar coordinates are mapped to one another) is provided to the radar device 14, and that guided beamforming of the radar device 14 is provided.

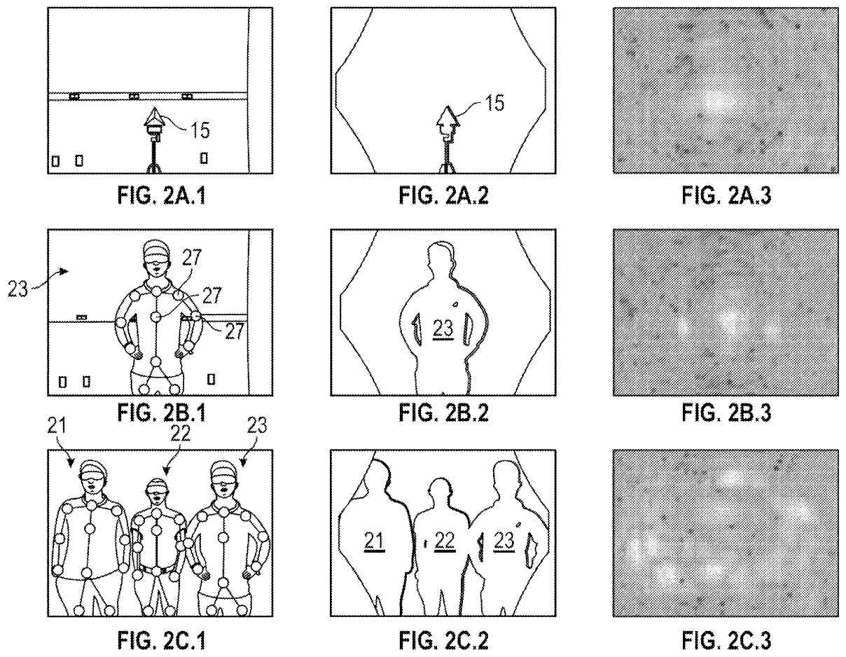

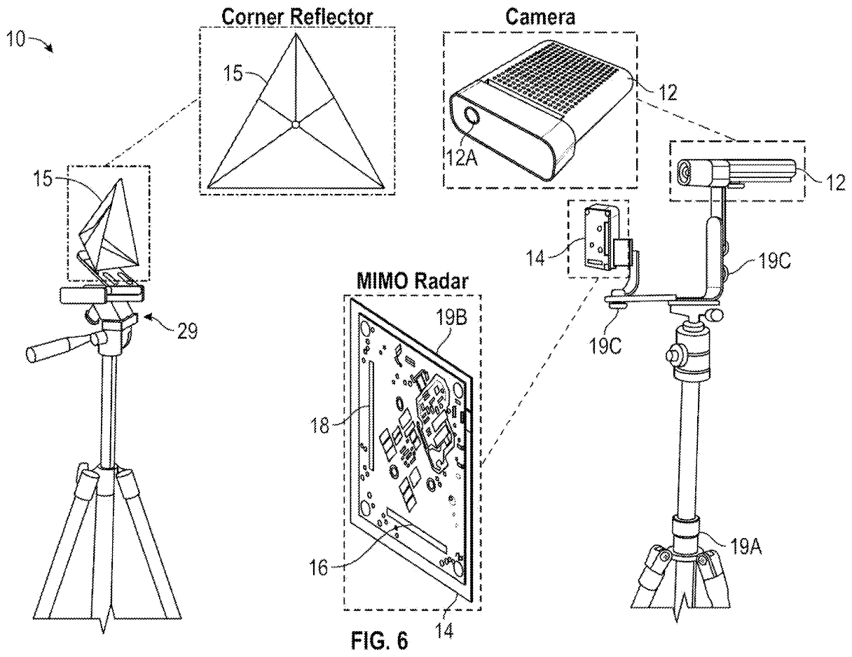

Human body landmarks (e.g., 25-27 in FIG. 1) are automatically recognized with the help of computer vision techniques. To map vision coordinates obtained with the optical camera 12 to radar coordinates obtained with the radar device 14, a systematic approach was developed. The setup involves a one-time calibration process by sequentially placing a corner reflector (e.g., 15 in FIGS. 2A.1 and FIG. 6) at different positions in the field of view 13 of the dual sensing apparatus 10, and then recording (e.g., collecting) corner reflector locations by the camera 12 and the radar device 14 (e.g., recording radar coordinates corresponding to peak locations of an energy cluster of radar energy reflected by a corner reflector, and recording visual coordinates of a reflective center of the corner reflector). The 3-D coordinates of the corner reflector recorded by the camera 12 and the radar device 14 form training data that is used to solve an affine transformation with twelve degrees of freedom that can describe the 3-D translation and rotation. After the calibration, the affine transformation coefficients are determined and used to construct beamforming weights for further use of the radar device 14. Mapping of camera coordinates to radar coordinates within the field of view of the dual sensing apparatus 10 enables high precision guided beamforming of the MIMO radar device 14.

FIGS. 4A.1 and 4A.2 provide front and rear views, respectively, of a MIMO imaging radar device 14 according to one embodiment. A body structure 19B includes a circuit board 15 that supports a MIMO array having twenty transmit antennas (Tx) 16A-16T (in Tx array 16) by twenty receive antennas (Rx) 18A-18T (in Rx array 18). The circuit board 15 also supports a computing device (e.g., microprocessor) 5 and a memory 6 (as shown in FIG. 4A.2). In certain embodiments, the computing device 5 is configured to control the MIMO array (including Tx array 16 and Rx array 18), and is also configured to utilize collected radar coordinates and collected visual coordinates to generate a transformation function that maps visual coordinates to radar coordinates, wherein the transformation function (after generation) may be stored in the memory 6.

Disclosed herein are a novel vision-guided MIMO radar sensing system consisting of a MIMO imaging radar device and a 3-D depth camera, and a systematic approach to align the radar and 3-D depth camera coordinates. The localization performance of the dual sensing apparatus with a corner reflector in a three-dimensional environment was characterized. A novel vision guided MIMO radar beamforming method for vital signs detection was demonstrated with multiple subjects in the cluttered office environment.

### Motivation for Vision Guided Radar

Visual images, both RGB (red-green-blue) and depth, from 3-D cameras provide far more visual contexts and textures than an advanced radar imaging system alone. Computer vision techniques and tools are already available and can be directly applied to visual images for human subject recognition [22] and pose estimation [23]. These tasks are quite challenging to achieve with imaging radars. Since the accuracy of the detection/recognition task is directly related to the imaging resolution, it is important to note that the imaging resolution is measured differently for cameras and radars. For an optical device, the imaging resolution is given by the number of pixels. For a MIMO imaging radar, the imaging resolution is determined by the number of array elements and their locations.

In FIGS. 2A.1 through 3B.3, a black and white traced representation is provided of an RGB image having 1920 pixels horizontally by 1080 vertically, while the radar image is generated by a L-shape array with 20 physical elements arranged horizontally by 20 physical elements vertically arranged (see FIGS. 4A.1 and 4A.2) and forming a 400-element virtual array (as shown in FIG. 4C). Since the RGB image and depth map are aligned, each pixel in the RGB image corresponds to a depth value in the depth image.

FIGS. 2A.1 through 2C.3 show black and white traced snapshot RGB images, black and white traced depth images, and radar images for a corner reflector, a single human subject, and three human subject standing at the same imaging plane with respective to the sensor plane. Specifically, FIGS. 2A.1, 2A.2, and 2A.3 provide a black and white traced RGB image, a black and white traced depth image, and a radar image, respectively, of a corner reflector arranged within a field of view of a camera-radar dual sensing apparatus. FIGS. 2B.1, 2B.2, and 2B.3 provide a black and white traced RGB image, a black and white traced depth image, and a radar image, respectively, of a single human subject arranged within a field of view of the camera-radar dual sensing apparatus, with human body landmarks represented as circles in the RGB image of FIG. 2B.1. FIGS. 2C.1, 2C.2, and 2C.3 provide a black and white traced RGB image, a black and white traced depth image, and a radar image, respectively, of three human subjects arranged within a field of view of the camera-radar dual sensing apparatus, with human body landmarks represented as circles in the RGB image of FIG. 2C.1. Clearly, the visual images from the camera capture detailed structure of the imaging target for reflector and human subjects. Also, the object contour is revealed in the depth map. However, the radar images provide abstract information in the environment. Note that a corner reflector is commonly used to calibrate electromagnetic wave devices by generating a larger radar cross-section. When imaging multiple subjects, the response pattern becomes complicated, which makes the automatic association of the radar return with each human subject almost impossible without a visual reference.

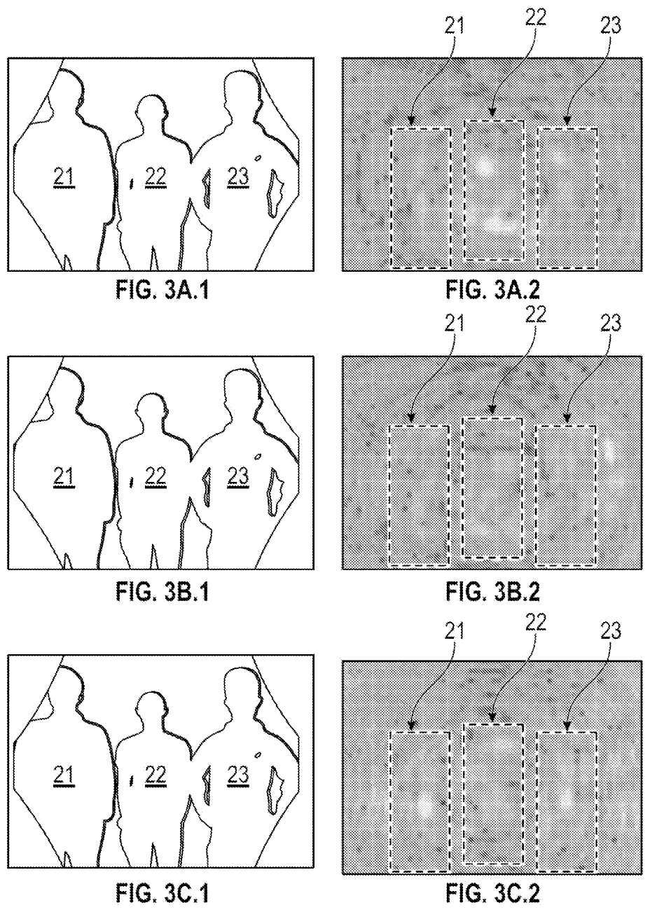

Imaging instability is another potential issue in radar imaging-based sensing. This issue is demonstrated in FIGS. 3A.1 to 3C.2. Three snapshots are randomly selected from a short 5-second recording. FIGS. 3A.1, 3A.2, and 3A.3 each provide one black and white traced depth imaging snapshot of three human subjects in a FOV of a camera-radar dual sensing apparatus from a five-second-long dataset. FIGS. 3B.1, 3B.2, and 3B.3 each provide one radar imaging snapshot of three human subjects in a FOV of a camera-radar dual sensing apparatus from a five-second-long dataset (with addition of dashed line boxes around subjects), exhibiting greater variation between frames than in FIGS. 3A.1, 3A.2, and 3A.3. The imaging results from the radar fluctuates over time, leading to ambiguity and unreliable localization. Low emitting power, weaker reflection from human subjects compared to the clutterers, and sensitivity to involuntary body motion can explain this outcome.

### MIMO Radar Signal Processing

### A. SFCW Signal Model

The 3-D radar imaging system deploys stepped-frequency continuous-wave (SFCW) signaling and operates in the frequency domain rather than the time domain [24]. The SFCW radar transmits a series of discrete narrow-band pulses in a stepwise manner to achieve a larger effective bandwidth. The modulated waveform consists of a group of N coherent pulses with pulse duration T, and frequencies fₙ=f₀+nΔf. Assume that each SFCW waveform has N pulses called one SFCW, the frame and the center frequency of the first pulse is f₀, as illustrated in FIG. 4B, which is a plot of frequency versus time of a stepped-frequency continuous-wave (SFCW) signaling scheme implemented with a time division multiplexing MIMO configuration.

One transmitted SFCW frame is represented as a sum of N windowed narrow band signals, according to Equation (1):

$${s}_{T} ( τ ) = \frac{1}{\sqrt{T}} {\sum }_{n} rect ( \frac{τ - n T}{T} ) {e}^{j 2 π ( {f}_{0} + n Δ f ) τ} . \qquad ( 1 )$$

The backscattered SFCW frame in the baseband is modeled by concatenating the down-converted received pulses. The received pulse is an attenuated and delayed version of the transmitted pulse at some distance. The range profile is obtained by performing inverse Fourier transform of the fast frequency samples. The slow-time signal at the target range is approximated as by ignoring other constant terms [25], according to Equation (2):

S_{R}(t)≈e^{j2πf}^{₀}^{τ}^{_{D}}^{(t)}, (2)

where T_{D}(t)=2R_{T}(t)/c denotes a slowly time-varying delay due to target motion R_{T}(t). c denotes the speed of light.

### B. Time Division Based MIMO Configuration

The SFCW signal frames were transmitted in a time division multiplexing (TDM) MIMO configuration by transmitting sequentially through the Tx antennas while the Rx antennas are acquiring the data all the time.

The MIMO virtual array is obtained by convolving the Tx and the Rx aperture functions g_{T} (x, y, z), g_{R}(x, y, z). For convenience, the last dependent variable z is dropped since the Tx and the Rx arrays lie on the same z=zₐ plane. Thus, for the transmit array, the aperture illumination function is defined according to Equation (3):

$${g}_{T} ( x , y ) = {\sum }_{{n}_{T} = 1}^{{N}_{T}} δ ( x - {x}_{T , {n}_{T}} , y - {y}_{T , {n}_{T}} ) . \qquad ( 3 )$$

For the receiver array, the aperture illumination function is defined according to Equation (4):

$${g}_{R} ( x , y ) = {\sum }_{{n}_{R} = 1}^{{N}_{R}} δ ( x - {x}_{R , {n}_{R}} , y - {y}_{R , {n}_{R}} ) . \qquad ( 4 )$$

The virtual array is given by Equation (5):

$$g ( x , y ) = ( {g}_{T} * {g}_{R} ) ( x , y ) = {\sum }_{{n}_{T} = 1}^{{N}_{T}} {\sum }_{{n}_{R} = 1}^{{N}_{R}} δ ( x - ( {x}_{T , {n}_{T}} + {x}_{R , {n}_{R}} ) , \qquad ( 5 )$$

$$y - ( {y}_{T , {n}_{T}} + {y}_{R , {n}_{R}} ) )$$

where x and y together form coordinates within a 2-D plane, and δ(.) denotes the Dirac delta function. Two linearly separated Tx antennas with spacing A and receive (Rx) array with spacing λ form an N_{T}×N_{R} (400-element) virtual array as shown in FIG. 4(c).

### C. Spatial Beamforming

BF is applied to isolate multiple individuals and increases the received signal-to-noise ratio (SNR). For a multiple Rx antenna system, the signal model in Eqn. (2) will accordingly have an additional phase shift representing the phase progression across the array. For a target at an azimuth angle θ and an elevation angle φ, the signal received from the m-th frame at the virtual element corresponding to the n_{T}-th Tx antenna and the n_{R}-th Rx antenna is determined according to Equations (6) and (7),

$$\begin{matrix}{s}_{R} ( t \vert {n}_{T} , {n}_{R} ) & = & {e}^{j 2 π {f}_{0} {τ}_{D} ( t )} {e}^{j 2 π \frac{sin ( θ ) {D}_{x} + cos ( ϕ ) {D}_{y}}{λ}} & ( 6 ) \\ & = & {e}^{j 2 π {f}_{0} {τ}_{D} ( t )} & ( 7 ) \\ & \times & {e}^{j 2 π ( sin ( θ ) ( {n}_{T} - 1 ) + cos ( ϕ ) ( {n}_{R} - 1 ) )} , & \end{matrix}$$

where Dₓ=x_{T,n}T+x_{R,n}R and D_{y}=y_{T,n}T+y_{R,n}R. λ is the wavelength. From Eqn. (6) to (7), the assumption of half-wavelength element spacing is invoked. The output of the BF is provided by Equation (8):

$$\begin{matrix}{s}_{R} ( t ) = {\sum }_{{n}_{T}} {\sum }_{{n}_{R}} {s}_{R} ( t \vert {n}_{T} , {n}_{R} ) {w}_{{n}_{T} , {n}_{R}}^{*} ( θ , ϕ ) , \\ = {N}_{T} {N}_{R} {e}^{j 2 π {f}_{0} {τ}_{D} ( t )}\end{matrix} \qquad ( 8 )$$

$$where {w}_{{n}_{T} , {n}_{R}} ( θ , ϕ ) = {e}^{j 2 π ( ( {n}_{T} - 1 ) sin θ + ( {n}_{R} - 1 ) cos ϕ )} .$$

### D. 3-D Radar Imaging

Imaging an object in a reflection arrangement is understood as the process of correlating the information of the reflected scattered field out of the object from multiple angles of view in order to find a description of the object function. In the imaging arrangement, Tx array and Rx array are placed at different positions within the z=z_{z} plane. The collected data include all possible combinations of Tx and Rx at all frequencies of operation.

The scattered field y(xₜ, yₜ, xᵣ, yᵣ, k) can be written as a volume integration using Equation (9):

$$γ ( {x}_{t} , {y}_{t} , {x}_{r} , {y}_{r} , k ) = {\int }_{x} {\int }_{y} {\int }_{z} dx dy dz O ( x , y , z ) \times {e}^{- j k \sqrt{{( {x}_{t} - x )}^{2} + {( {y}_{t} - y )}^{2} + {( {z}_{a} - z )}^{2}}} \times {e}^{- j k \sqrt{{( {x}_{t} - x )}^{2} + {( {y}_{t} - y )}^{2} + {( {z}_{a} - z )}^{2}}} \qquad ( 9 )$$

The imaged object O(x, y, z) is reconstructed by solving the above inverse problem. The imaging reconstruction problem is solved based on spatial frequency domain representation [26]. After taking 4-D Fourier transform on both sides of Eqn. (9) with respect to xₜ, yₜ, xᵣ, yᵣ, a more convenient representation, which matches the MIMO SFCW radar data recording in the frequency domain, is given by Equation (10):

γ(xₜ,yₜ,xᵣ,yᵣ,k)=F⁻¹{Γ(kₓ_{ₜ},k_{y}_{ₜ},kₓ_{ᵣ},k_{y}_{ᵣ},k)}. (10)

kₓₜ, k_{yt}, kₓᵣ, k_{yr} are the Fourier domain variables corresponding to xₜ, yₜ, xᵣ, yᵣ. Plugging Eqn. (9) into Eqn. (10) and through some mathematical manipulations, the reconstructed object function using spatial frequency domain representation is hence expressed according to Equation (11):

Ô(x,y,z)=F⁻¹{Γ(kₓ_{ₜ},k_{y}_{ₜ},kₓ_{ᵣ},k_{y}_{ᵣ},k)×e^{-jk}^{_{z}}^{z}^{ₐ}}, (11)

where

$${k}_{z} = \sqrt{{k}^{2} - {k}_{{x}_{t}}^{2} - {k}_{{y}_{t}}^{2}} + \sqrt{{k}^{2} - {k}_{{x}_{r}}^{2} - {q}_{{y}_{r}}^{2}} . \qquad ( 12 )$$

### Camera-Radar Dual Sensing Apparatus

Vision is expected to be more accurate than radar and the latter has some fundamental issues to localize multiple closely spaced human targets as discussed in the previous sections. This motivates us to develop a new technique based on vision-guided radar beamforming for sensing purposes. In this section, we describe the proposed camera-radar dual sensing system.

### A. Camera-Radar Dual Sensing Apparatus Testbed

A camera-radar dual sensing apparatus according to one embodiment is shown in FIG. 6, which shows a camera-radar dual sensing apparatus 10 (including a MIMO radar device 14 including an array of radar transmitters 16 and an array of radar receivers 18, and at least one optical camera 12 (having lens 12A) configured to provide depth information) and showing a corner reflector 15 arranged in a field of view of the dual sensing apparatus 10. As illustrated, a substrate 19B is provided to support the radar transmitter and receiver arrays 16, 18, while a first tripod 19A with associated damps 19C is provided to positionally fix the MIMO radar device 14 and the optical camera 12 relative to one another. A second tripod 29 is also provided to support the corner reflector 15. As described previously, the

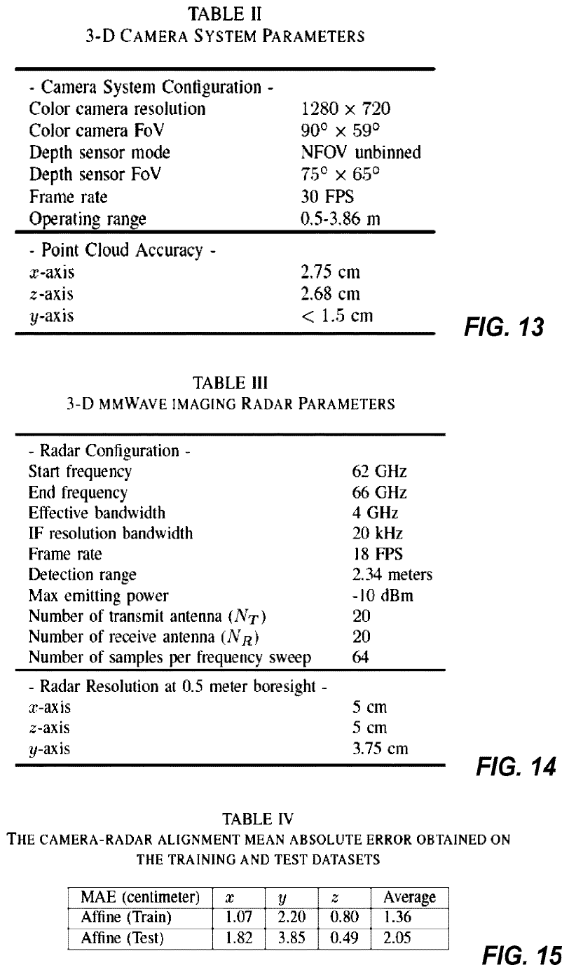

In one embodiment, the optical camera 12 comprises a 3-D depth camera, such as an Azure Kinec DK [27], [28], featuring a color (RGB) camera and an advanced depth sensor using time of flight (ToF) technology. The color camera portion of the optical camera 12 may be configured to provide 1280 by 720 resolution with a FoV of 90° by 59°. The depth camera portion of the optical camera 12 is configured to the “Narrow FOV unbinned” mode with a FoV of 75° by 65°. The operating range of the depth camera is 0.3 to 3.86 meters. The FoV of the camera 12 is defined as the intersection of the fields of view of color camera and depth sensor components. The operations of the color camera and the depth sensor are synchronized in time with a frame rate of 30 frames/second (FPS). The key parameters of this camera system are summarized in Table II (FIG. 13).

The mmWave imaging radar device 14 according to one embodiment shown in FIG. 6 employs NT=20 transmit antennas and NR=20 receive antennas and operates in the frequency domain with stepped-frequency-continuous wave (SFCW) signaling. The frequency sweep contains sixth-four samples and covers 62-66 GHz with a 4 GHz bandwidth. The maximum detecting range is 2.34 meters. The IF resolution bandwidth of the radar is set to 20 kHz (related to integration time). These radar parameters deliver an imaging frame rate of about 18 FPS, which is sufficient for processing human vital signs. The maximum emitting power of the radar is about −10 dBm. The key parameters of the radar are summarized in Table III (FIG. 14).

### B. Camera 3-D Point Cloud

The DK provides a 3-D point cloud C for all the pixels in the color image that lie in the common FoV of the color camera and the depth sensor. Let D and C denote the RGB image and the 3-D point cloud captured by the camera system in one frame. With N_{c} denoting the number of pixels, the 3-D point cloud can be written as

$$C = \{ {p}_{1}^{c} , … , {p}_{{N}_{c}}^{c} \} , where {p}^{c} = {[ {x}^{c} , {y}^{c} , {z}^{c} ]}^{T}$$

are the horizontal, vertical, and depth coordinates of each pixel.

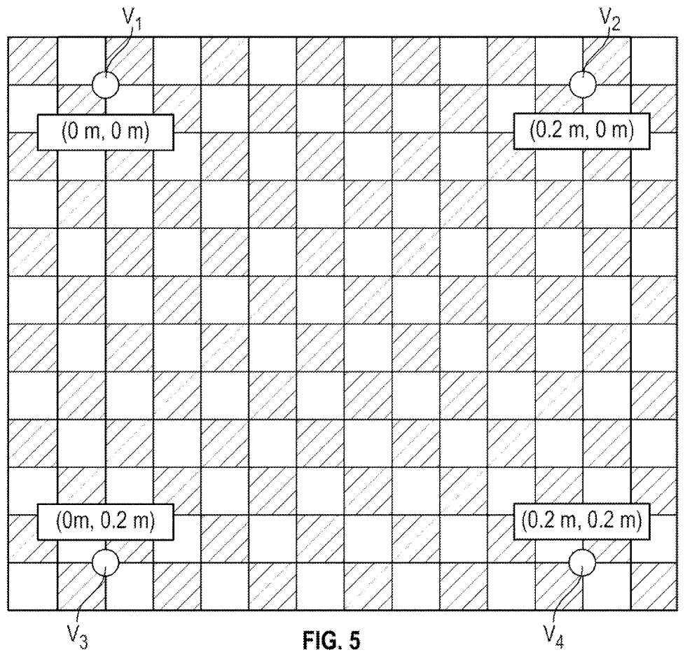

According to the hardware specifications [28], the depth error of the Azure Kinect DK camera is less than 11 mm plus 0.1% of distance without multi-path interference. This indicates that the mean absolute error (MAE) along the z-axis (depth) of C is smaller than 1.5 centimeter within 3.86 meters. A checkboard is used to evaluate the point cloud accuracy in C along the x and y axis. The checkboard is placed orthogonal to the camera z-axis and its checkboard grids are parallel to x and y axes. Four vertices on the checkboard are selected as anchor points for evaluation. The anchors points V₁ to V₄ are labeled as circular markers in FIG. 5. The distance among the four anchor points V₁ to V₄ are 20 centimeters vertically and horizontally. For accuracy evaluation, the relative distance among anchors points V₁ to V₄ are estimated from C as

$$( \vert {x}_{2}^{c} - {x}_{1}^{c} \vert + \vert {x}_{4}^{c} - {x}_{3}^{c} \vert ) / 2 and ( \vert {y}_{2}^{c} - {y}_{1}^{c} \vert + \vert {y}_{4}^{c} - {y}_{3}^{c} \vert ) / 2 ,$$

where

$${x}_{i}^{c}$$

and

$${y}_{i}^{c}$$

are the anchor coordinates from C. The MAE in x-axis and y-axis are 2.75 cm and 2.68 cm. The results are obtained by placing the checkboard at eight different positions.

### C. MIMO Radar 3-D Spatial Resolution

The range resolution of the radar is 3.75 centimeters at the boresight given the 4 GHz signaling bandwidth. The azimuth and elevation angular resolution are determined by the antenna array layout and aperture size. Given the L-shape array (with Tx and Rx components 16A-16T, 18A-18T positioned in linear arrays that are orthogonal to one another) in FIG. 4C, the angular resolution in x-axis and y-axis are the same. Virtual elements may be assigned transmit/receive pairs, such as illustrated at corner boundaries in FIG. 4C (i.e., (16A, 18A), (16T, 18A), (16A, 18T), (16T, 18T)). The angular resolution AB is described by Equation (13):

$$Δ θ = \frac{λ}{{N}_{T} {d}_{x} cos ( θ )} \qquad ( 13 )$$

where

$${d}_{x}^{}$$

denotes the array element spacing in azimuth. Given

$${N}_{T}^{} T = 20 and {d}_{x}^{} = λ / 2 ,$$

the best azimuth angular resolution occurs at the boresight, which is about 5.7°. The resulting x/y-axis spatial resolution in the Cartesian coordinate system at 0.5 meters is 5 cm.

### D. Camera-Radar Alignment

The goal of the camera-radar alignment is to estimate a transformation function

$$B : {p}_{}^{c} \to {p}_{}^{r}$$

that can map a targets camera coordinate to its radar coordinate, in which

$${p}_{}^{c} = ( {x}_{}^{c} , {y}_{}^{c} , {z}_{}^{c} ) and {p}_{}^{r} = ( {x}_{}^{r} , {y}_{}^{r} , {z}_{}^{r} )$$

denote the Cartesian coordinates of an ideal point target in the camera and radar co-ordinate systems. Mathematically, the optimal transformation function B* satisfies Equation (14):

$${B}^{★} = {arg max}_{B} {𝔼}_{p} \{ {‖ {p}^{r} - B ( {p}^{c} ) ‖}_{2}^{2} \} , \qquad ( 14 )$$

where p is a random point in the camera-radar FoV.

The transformation between the two coordinate systems can be modeled by an affine transformation, which can be used to describe the translation, reflection, rotation, and scaling transformations. Let

\tilde{p}^{c}=[x^{c},y^{c},z^{c},1]^{T} and \tilde{p}^{r}=[\hat{x}^{r},y^{r},z^{r},1]^{T}

denote the coordinates in the dual sensing apparatus. The mapping \tilde{p}^{r} is given by Equation (15):

\tilde{p}^{r}=B\tilde{p}^{c}, (15)

where B∈ [symbol] is the affine transformation matrix. B can be written by Equation (16):

$$B = [ \begin{matrix}{t}_{1 , 1} & {t}_{1 , 2} & {t}_{1 , 3} & {t}_{1 , 4} \\ {t}_{2 , 1} & {t}_{2 , 2} & {t}_{2 , 3} & {t}_{2 , 4} \\ {t}_{3 , 1} & {t}_{32} & {t}_{3 , 3} & {t}_{3 , 4} \\ 0 & 0 & 0 & 1\end{matrix} ] . \qquad ( 16 )$$

To estimate B, the dual sensing apparatus needs Kₜᵣ different measurements to collect the training data at Kₜᵣ different positions. Let

$${\tilde{P}}_{p}^{r} and {\tilde{P}}_{p}^{c}$$

denote the coordinates of the p-th (p∈{1, . . . , Kₜᵣ}) position. Combining Kₜᵣ measurements, Eqn. (15) can be re-written according to Equation (17):

\tilde{P}ᵣ=B\tilde{P}_{c}, (17)

where

$${\tilde{P}}_{r}^{} = [ {\tilde{p}}_{1}^{r} , … , {\tilde{p}}_{{K}_{t r}}^{r} ] and {\tilde{P}}_{c}^{} = [ {\tilde{p}}_{1}^{c} , … , {\tilde{p}}_{{K}_{t r}}^{c} ]$$

concatenate the coordinates of all the Kₜᵣ targets. Substitute the B into Eqn. (14), the optimal B can be estimated by solving the optimization problem of Equation (18):

$${arg min}_{B} {‖ {\tilde{P}}_{r} - B {\tilde{P}}_{c} ‖}_{F}^{2} , \qquad ( 18 )$$

where the ∥⋅∥_{F} denotes the Frobenius norm of a matrix. The least square estimated B can be obtained by Equation (19):

$$\hat{B} = {\tilde{P}}_{r} {\tilde{P}}_{c}^{†} , \qquad ( 19 )$$

where

$${\tilde{P}}_{c}^{†} = {{\tilde{P}}_{c} ( {\tilde{P}}_{c} {\tilde{P}}_{c}^{T} )}^{- 1}$$

denote the pseudo inverse of \acute{P}_{c}.

Kₜᵣ≥4 is required for estimating B to ensure that

$${\tilde{P}}_{c}^{}$$

is full row rank. The estimated radar coordinates \hat{p}^{r} is obtained by Equation (20):

\hat{p}^{r}=\hat{B}\tilde{p}^{c}. (20)

### E. Alignment Performance Evaluation

A highly reflective object is used in the calibration process. Each measurement position contains the RGB image, depth image, and radar image as shown in FIGS. 2A.1 to 2A.3. The RGB pixel capturing the center of the corner reflector is manually selected. The corresponding pixel in the depth point cloud C givens the camera coordinates pc. The peak location of the energy cluster in the radar image in FIG. 2A.3 is selected as the radar coordinate of the corner reflector center, p^{r}.

In total, 33 pairs of camera and radar coordinates are collected by placing the corner reflector at various locations in the FoV of the dual sensing apparatus. Among them Kₜᵣ=19 measurements are used as the training data to estimate \hat{B} in Eqn. (19). For evaluation of the calibrated dual sensing apparatus, the MAE along the x, y, and z axis is calculated using Kₜₑₛₜ=14 testing measurements. The MAE on the training and testing is summarized in Table IV (FIG. 15). The dual sensing apparatus achieves centimeter-level MAE performance on testing results. The disclosed method provides sufficient camera-radar alignment accuracy for the dual sensing apparatus, and thus can be utilized to realize the vision guided radar sensing task.

FIG. 4D provides a radar imaging example of a human subject 31 using a camera-radar dual sensing apparatus system according to one embodiment of the present disclosure. The radar image at left shows identifiable regions corresponding to head 32, torso 34, and arms 33 for a subject 31 schematically illustrated at right.

### Vital Signs Extraction

A pre-trained pose estimation model [29] is deployed to automatically estimate torso landmarks from single or multiple subjects. The target area for VSD is chosen as the center point of chest, which is interpolated based on the torso landmarks (i.e., a centermost circle within the chest region of each subject 21-23, as displayed in FIG. 1.) The mapping function transforms the target position x^{c}, y^{c}, and z^{c} in the camera coordinate to the radar coordinate \hat{x}^{r}, ŷ^{r}, and \hat{z}^{r} in Eqn. (20). The perspective angles θ₀ and φ₀ for VSD with respect to the boresight of the dual sensing apparatus are then calculated according to Equations (21) and (22):

$${θ}_{0} = arctan [ \frac{{\hat{x}}^{r}}{{R}_{0}} ] \qquad ( 21 )$$

$${ϕ}_{0} = arctan [ \frac{{\hat{y}}^{r}}{{R}_{0}} ] , \qquad ( 22 )$$

where R₀ denotes the radial distance from the sensor to the human subject, given by

$${R}_{0} = {R}_{0} = \sqrt{{( {\hat{x}}_{}^{r} )}^{2} + {( {\hat{y}}_{}^{r} )}^{2} + {( {\hat{z}}_{}^{r} )}^{2}} .$$

The spatial channels are constructively combined to enhance SNR given a weak emitting power at maximum −10 dBm. The radial distance R₀ determines the range bin for VSD. The phase component at R₀ is extracted by taking the unwrapping function and angle function on Eqn. (2),

Ψ(t)=unwrap[angle[S_{R}(t)]]. (23)

The RR and HR are estimated by locating the spectral peaks in the relevant frequency regions. Prior to taking FFT on the phase signal, a high pass filter is applied to remove the DC component and the phase differential method [14] is also applied to emphasize weak heartbeat signal, according to Equation (24):

$$ψ ( t ) = \frac{δ Ψ ( t )}{δ t} . \qquad ( 24 )$$

### Experiments

### A. Result Analysis

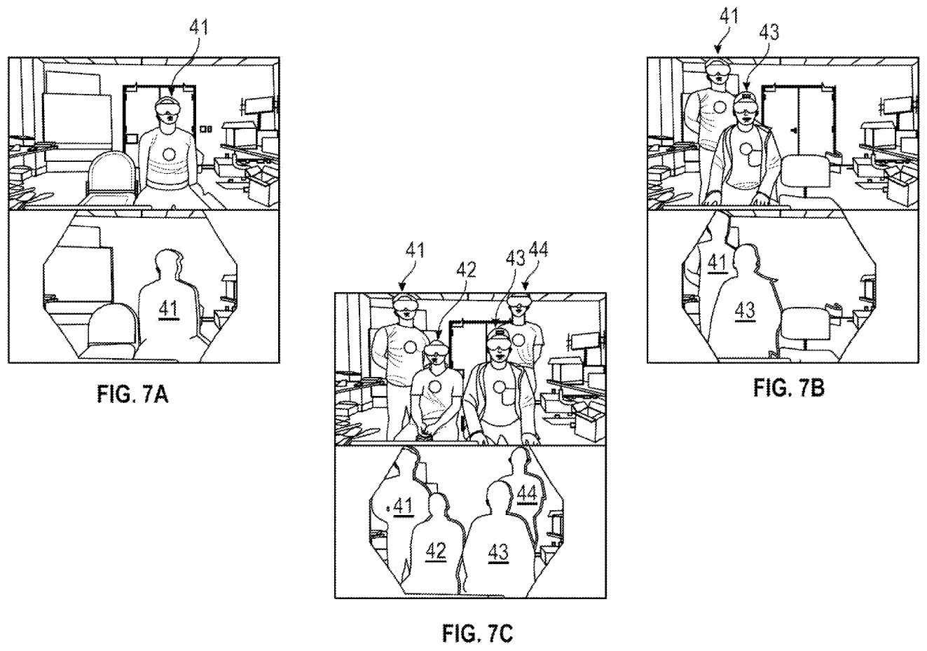

Utilization of camera-radar dual sensing apparatus is validated in three human tests shown in FIGS. 7A-7C. Signal quality is inspected at the various stages in the processing chain in the first experiment FIG. 7A. Two human subjects separated in elevation direction is demonstrated in FIG. 7B, in which one subject is standing right behind a seating subject. Lastly, VSD from a group of four closely spaced subjects is performed in the last experiment FIG. 7C. In particular, FIG. 7A includes an upper frame embodying a black and white traced RGB image with torso landmarks, and includes a lower frame embodying a depth image, for a first experiment scene including a single human subject 41. FIG. 7B includes an upper frame embodying a black and white traced RGB image with torso landmarks, and includes a lower frame embodying a black and white traced depth image, for a second experiment scene including two human subjects 41, 43. FIG. 7C includes an upper frame embodying a black and white traced RGB image with torso landmarks, and includes a lower frame embodying a black and white traced depth image, for a third experiment scene including a group of four human subjects 41-44.

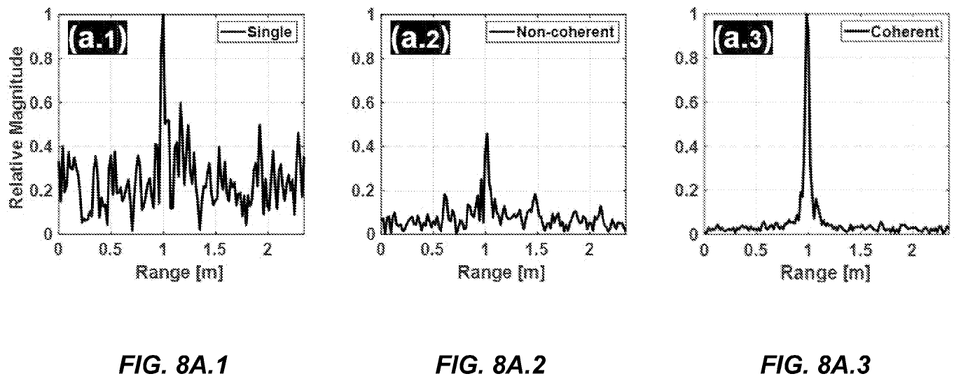

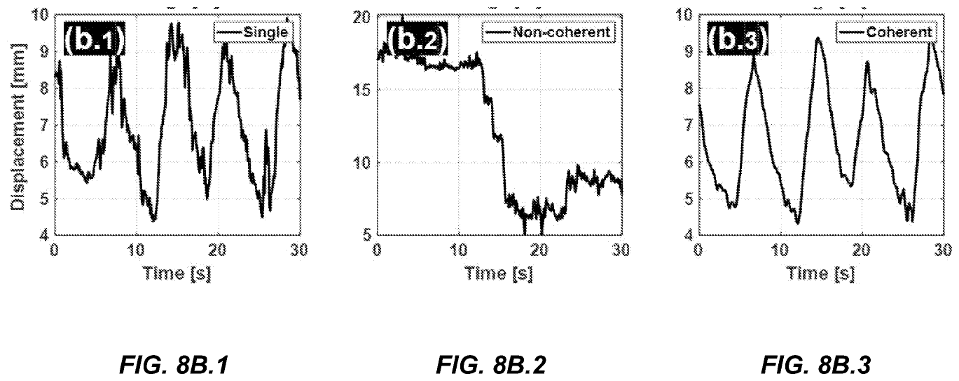

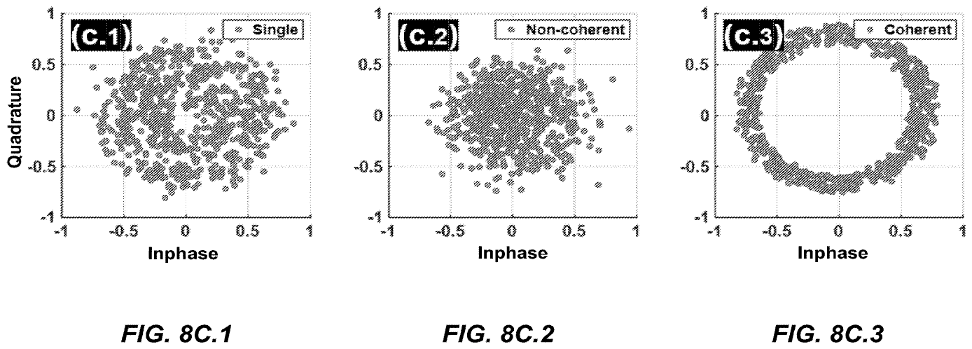

Signal Enhancement: Constructively combining the spatial channels significantly improves the signal quality in various forms. FIGS. 8A.1 to 8A.3 compare the one snapshot of the range profile from different data processing, single channel only, non-coherent summing all spatial channels and coherent combining. Specifically, FIGS. 8A.1, 8A.2, and 8A.3 provide range profiles (relative magnitude versus range) obtained using a camera-radar dual sensing apparatus and processed according to three different processing techniques, namely: single channel, non-coherent combining of all channels, and coherent combining, respectively. Clearly, the range profile from coherent processing gives the best peak detection performance. The naive summation of the spatial channels even degrades the range profile as the subject is at a tilted angle.

FIGS. 8A.1, 8A.2, and 8A.3 provide range profiles (relative magnitude versus range) obtained using a camera-radar dual sensing apparatus and processed according to three different processing techniques, namely: single channel, non-coherent combining of all channels, and coherent combining, respectively. Similar results are observed in FIGS. 8B.1 and 8B.2. The estimated respiration pattern after beamforming (shown in FIG. 8B.3) is less noisy than the single channel result (of FIG. 8B.1), while FIG. 8B.2 produces an unmeaningful signal pattern. Another way to inspect signal quality is to visualize the in-phase and quadrature components. The phase noise performance is dramatically improved as shown in FIG. 8C.1 to 8C.3, wherein FIG. 8C.3 is shown as a circular arc, while FIG. 8C.1 and FIG. 8C.2 give noise clouds. FIGS. 8C.1, 8C.2, and 8C.3 provide phase signals (quadrature versus in-phase) obtained from the respiration patterns of FIGS. 8B.1, 8B.2, and 8B.3 and processed with three different processing techniques, namely: single channel, non-coherent combining of all channels, and coherent combining, respectively.

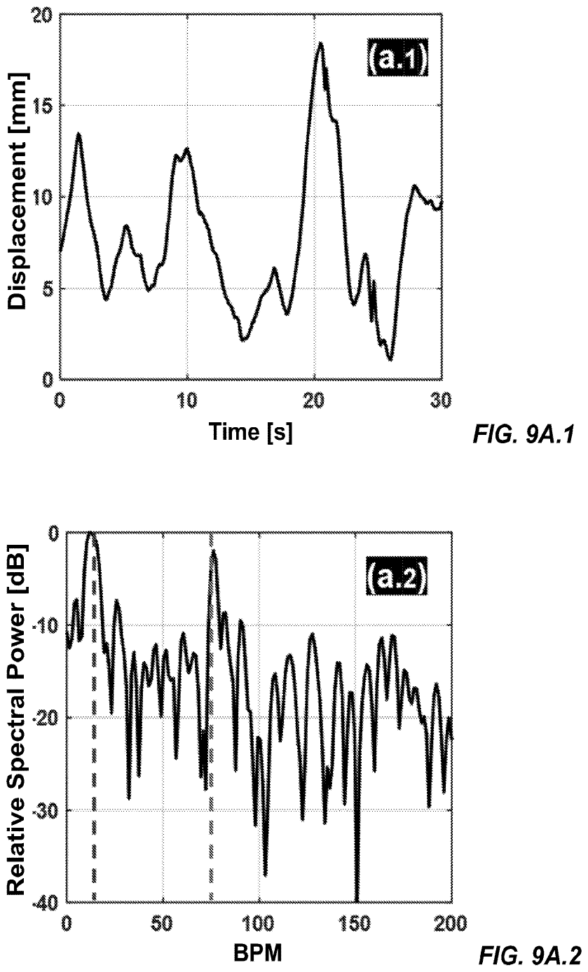

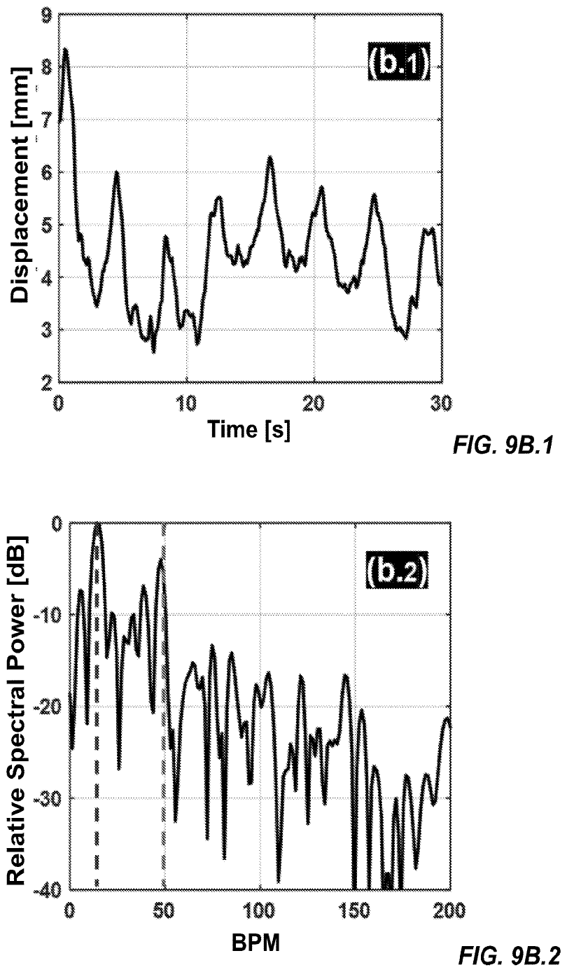

Elevation Separation: To the best of the authors' knowledge, this is the first study on separating closely spaced subjects in elevation direction using wireless signals and thus recovering vital signs from each individual. The estimated respiration patterns from the two subjects are displayed in FIGS. 9A.1 and 9B.1. The corresponding spectra are given in FIGS. 9A.2 and 9B.2. The seating subject produces a slow but irregular respiration pattern (FIG. 9A.1) while the standing subject shows a fast regular respiration pattern (FIG. 9B.1). This observation matches with the respiration rate (RR) estimate. Slow breath leads to a low RR of about 12 beats per minute (BPM) while fast breath leads to a high RR of about 17 BPM. The two subjects also exhibit very different resting heart rate (HR) (e.g., 78 BPM for the seating subject and 49 BPM for the standing subject. The resting HR estimation is produced from a 15-second data and the estimation is consistent with the HR reference derived from the oximeter. The vast difference in resting HR depends on the subject's physical condition, gender, height, and lifestyle.

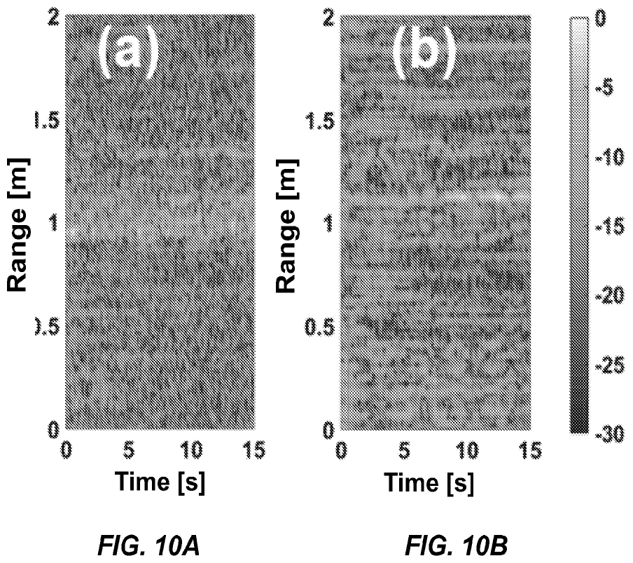

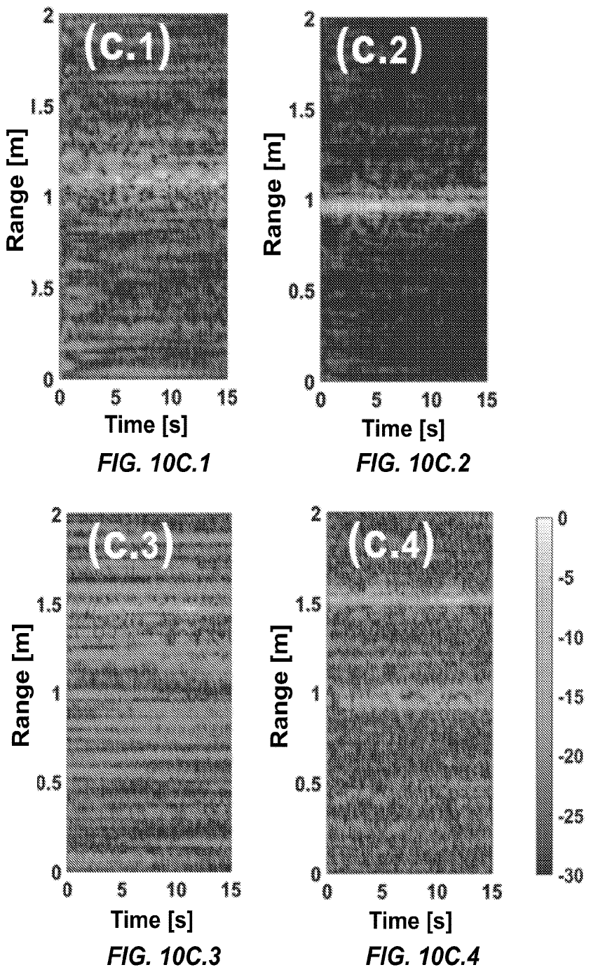

Group of Four Subjects: The last demonstration proves the working of the proposed dual sensing apparatus in crowded space. To visually inspect the isolation performance of a group of subjects, the range-time heatmaps from each individual are displayed in FIGS. 10C.1 to 10C.4 in comparison with the single channel (FIG. 10A) and non-coherent combining (FIG. 10B). FIGS. 10A and 10B provides range-time heatmaps (represented in dB power) of all four subjects for the experiment characterized in FIG. 7C, utilizing single channel processing and processing by non-coherent combining of all channels, respectively. The scene of the experiment is shown in FIG. 7C. FIGS. 10C.1 to 10C.4 provide separate range-time heatmaps for the four human subjects of the experiment characterized in FIG. 7C with vision aided beamforming for separating the four human subjects. FIGS. 10C.1 to 10C.4 are obtained by steering radar BF towards the vision guided directions. The four subjects are located at different radial distances to the system. The strongest color strips in FIGS. 10C.1 to 10C.4 indicate the target locations. They occur at approximately 1.1 m in FIG. 10C.1, 0.98 m in FIG. 10C.2, 1.47 m in FIG. 10C.3, and 1.54 m in FIG. 10C.4. In comparison, it is impossible to infer multiple subjects in FIGS. 10A and 10B as they are closely spaced and mixed with each other showing only faded strips. Additionally, the dynamic range is much wider in FIGS. 10C.1 to 10C.4 in comparison with FIGS. 10A and 10B. Closer subjects enjoy stronger signal return and thus higher dynamic range in FIG. 10C.2.

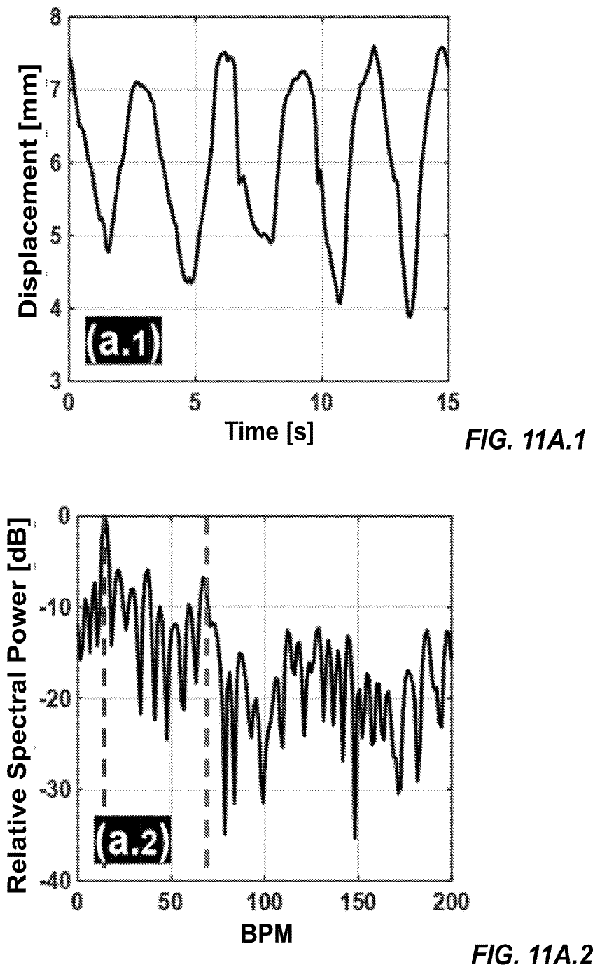

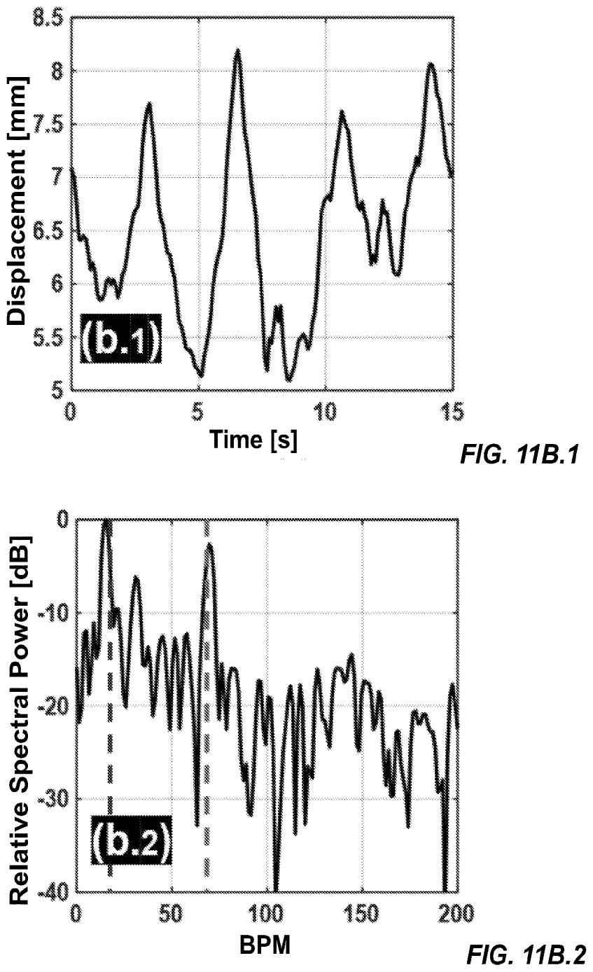

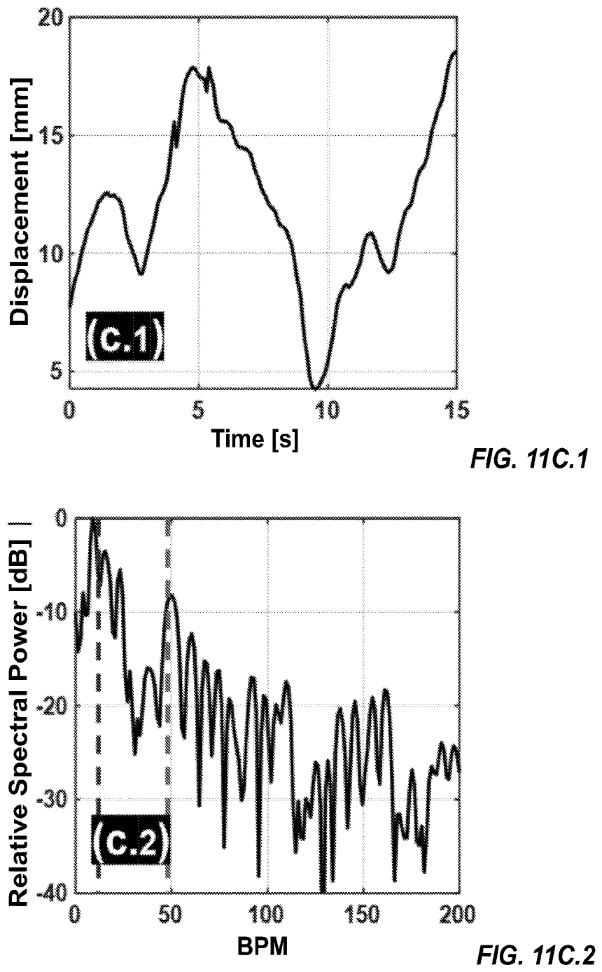

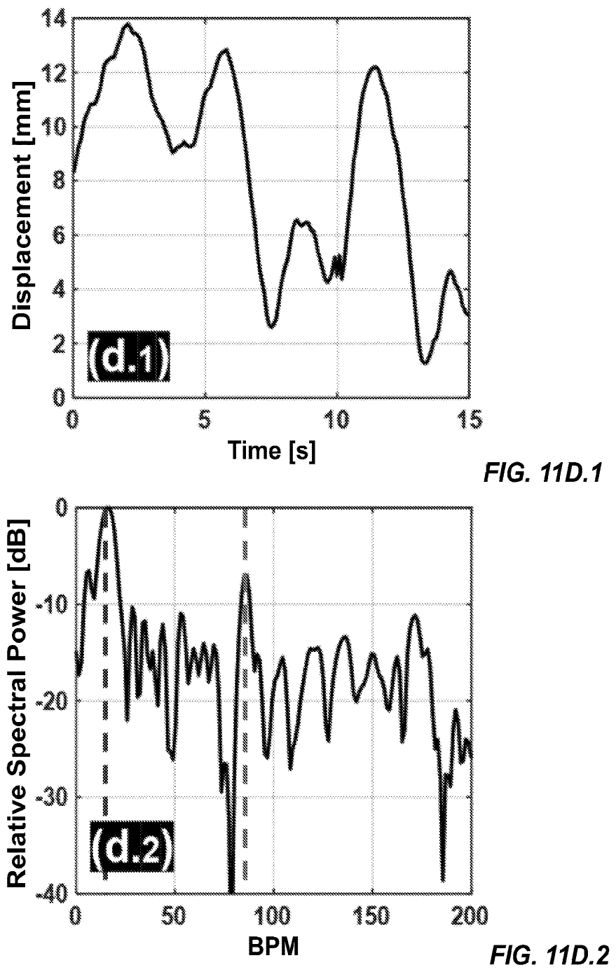

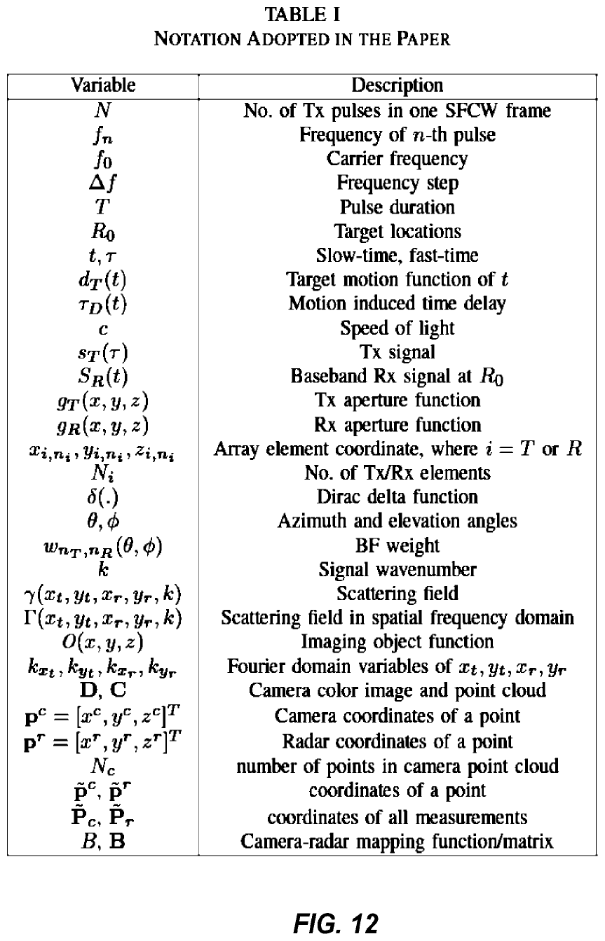

The estimated vital signs from the four subjects are plotted in FIGS. 11A.1 to 11D.2. FIGS. 11A.1, 11B.1, 11C.1, and 11D.1 display the distinctive respiration patterns and FIGS. 11A.2, 11B.2, 11C.2, and 11D.2 show the vital signs spectra with the RR and HR highlighted. All the spectral HR signatures are identifiable. The estimated values are within 2 BPM error from the reference values. In particular, the estimated HRs for lower-left subject, lower-right subject, top-left subject, top-right subject are 63 BPM, 78 BPM, 50 BPM and 85 BPM while the reference HRs are 64 BPM, 77 BPM, 48 BPM and 85 BPM, respectively.

B. Comparison with State of the Art Methods.

A comparison study between methods described herein and other recently developed methods is provided. The main consideration is whether the proposed system can be generalized to practical environments. One typical scene is a group of people in a tight office. This is challenging for the radar itself to automatically identify the number of subjects and also separate vital sign signatures from nearby subjects. For radar-only systems, the vital sign Doppler is often used to achieve human subject identification and localization in the Doppler enhanced range-angle map [31]-[33]. Additionally, most radar based methods required knowledge of the number of subjects. A recent study [32] exploited eigenvalue decomposition and signal subspace estimation for widely separated human subjects. However, when two subjects are closely spaced, both the steer vectors and the human vital signs are statistically similar and thus the decomposed signals from the radar return are highly correlated. This approach will underestimate the number of subjects. By introducing computer vision, the radar sensing capability can be significantly improved. This is evidenced in [17] but the dual system was limited to single-subject scenario. The concept of fusion camera motion information and radar signal to cancel random body motion is of profound interest and can be readily incorporated into our system to enable robust sensing of free-living subjects. The most related work on mapping 3-D depth camera and MIMO radar with limited array size [19] was not able to separate multiple closely spaced subjects. The alignment method between camera and radar only considered linear translations and thus cannot be generalized for rotational offsets.

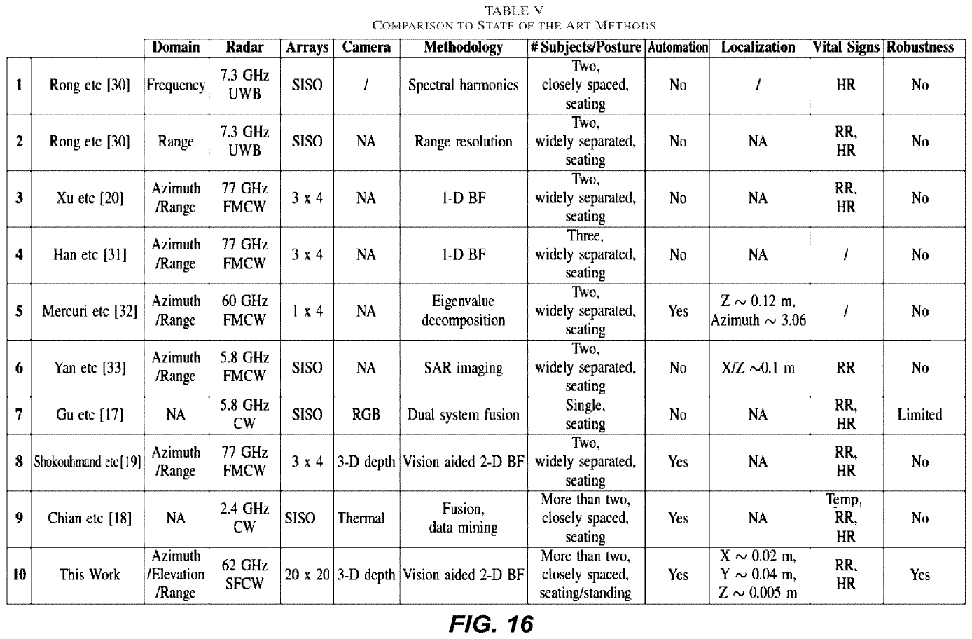

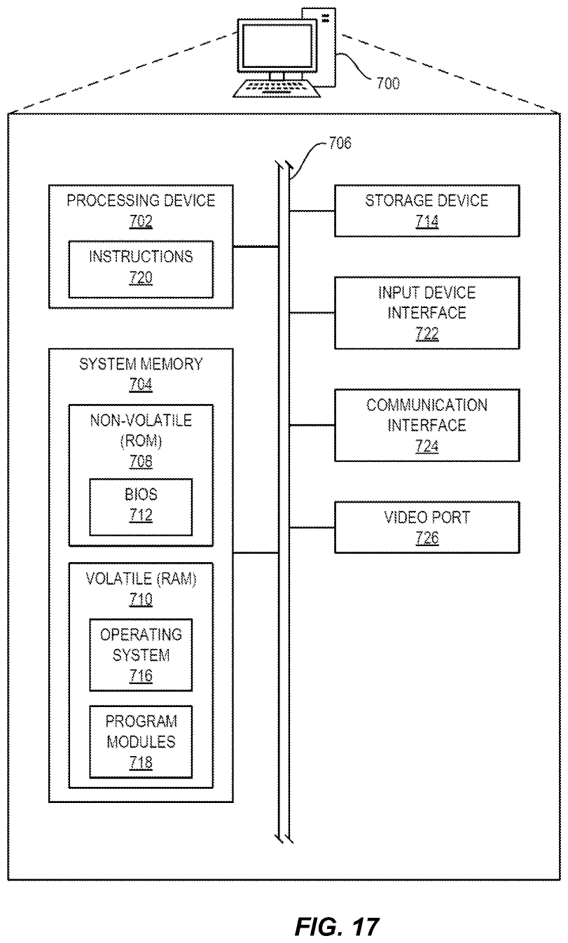

The overall comparison under various factors are summarized in Table V (FIG. 16). A fair comparison of VSD from these prior works is difficult because VSD performance is highly depends on the Tx power, number of subjects, perspective angle, distance, and processing window length. As a concrete example, the maximum radar Tx power of the developed system is −10 dBm while the systems adopted in the list have much higher Tx power as high as 12 dBm. Another evidence is that the coherent processing window from these works varied from 12 s to 50 s. In that regard, only the types of measurement were listed, such as RR and HR, in our VSD performance comparison.

FIG. 17 is a block diagram of a computer system 700 suitable for operating and/or calibrating a vision-guided radar beamforming system according to embodiments disclosed herein. The computer system 700 comprises any computing or electronic device capable of including firmware, hardware, and/or executing software instructions, suitably interfaced with camera-radar dual sensing apparatus components described herein, that could be used to perform any of the methods or functions described above. In this regard, the computer system 700 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 700 in this embodiment includes a processing device 702 or processor (also known as a computing device), a system memory 704, and a system bus 706. The system memory 704 may include non-volatile memory 708 and volatile memory 710. The non-volatile memory 708 may include read-only memory (ROM), erasable programmable read-only memory (EPROM), electrically erasable programmable read-only memory (EEPROM), and the like. The volatile memory 710 generally includes random-access memory (RAM) (e.g., dynamic random-access memory (DRAM), such as synchronous DRAM (SDRAM)). A basic input/output system (BIOS) 712 may be stored in the non-volatile memory 708 and can include the basic routines that help to transfer information between elements within the computer system 700.

The system bus 706 provides an interface for system components including, but not limited to, the system memory 704 and the processing device 702. The system bus 706 may be any of several types of bus structures that may further interconnect to a memory bus (with or without a memory controller), a peripheral bus, and/or a local bus using any of a variety of commercially available bus architectures.

The processing device 702 represents one or more commercially available or proprietary general-purpose processing devices, such as a microprocessor, central processing unit (CPU), or the like. More particularly, the processing device 702 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 702 is configured to execute processing logic instructions for performing the operations and steps discussed herein.

In this regard, various illustrative logical blocks and computational functions described in connection with the embodiments disclosed herein may be implemented or performed with the processing device 702, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 702 may be a microprocessor, or may be any conventional processor, controller, microcontroller, or state machine. The processing device 702 may also be implemented as a combination of computing devices (e.g., a combination of a DSP and a microprocessor, a plurality of microprocessors, one or more microprocessors in conjunction with a DSP core, or any other such configuration).

The computer system 700 may further include or be coupled to a non-transitory computer-readable storage medium, such as a storage device 714, which may represent an internal or external hard disk drive (HDD), flash memory, or the like. The storage device 714 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 716 and any number of program modules 718 or other applications can be stored in the volatile memory 710, wherein the program modules 718 represent a wide array of computer-executable instructions corresponding to programs, applications, functions, and the like that may implement the functionality described herein in whole or in part, such as through instructions 720 on the processing device 702. The program modules 718 may also reside on the storage mechanism provided by the storage device 714. As such, all or a portion of the functionality described herein may be implemented as a computer program product stored on a transitory or non-transitory computer-usable or computer-readable storage medium, such as the storage device 714, volatile memory 710, non-volatile memory 708, instructions 720, and the like. The computer program product includes complex programming instructions, such as complex computer-readable program code, to cause the processing device 702 to carry out the steps necessary to implement the functions described herein.

An operator, such as the user, may also be able to enter one or more configuration commands to the computer system 700 through a keyboard, a pointing device such as a mouse, or a touch-sensitive surface, such as the display device, via an input device interface 722 or remotely through a web interface, terminal program, or the like via a communication interface 724. The communication interface 724 may be wired or wireless and facilitate communications with any number of devices via a communications network in a direct or indirect fashion. An output device, such as a display device, can be coupled to the system bus 706 and driven by a video port 726. Additional inputs and outputs to the computer system 700 may be provided through the system bus 706 as appropriate to implement embodiments described herein.

In this disclosure, a camera-radar dual-sensor system is presented in which computer vision techniques are leveraged to significantly enhance radar sensing performance in crowded environments. A calibration routine to align the 3-D coordinates from the two imaging modalities is further presented. VSD algorithms that automatically localize multiple subjects and extract their vital signs are also provided. The utilization of two remote sensing technologies, vision plus wireless radar, opens up numerous potential applications for intelligent healthcare. Systems and methods disclosed herein may be used to monitor vital signs of multiple subjects subject to movement in an environment.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

It will be apparent to those skilled in the art that various modifications and variations can be made without departing from the spirit or scope of the invention.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

### REFERENCES

1. C. Gu, “Short-range noncontact sensors for healthcare and other emerging applications: A review,” Sensors, vol. 16, no. 8, p. 1169, 2016.
2. D. J. McDuff, J. R. Estepp, A. M. Piasecki, and E. B. Blackford, “A survey of remote optical photoplethysmographic imaging methods,” in 2015 37th annual international conference of the IEEE engineering in medicine and biology society (EMBC). IEEE, 2015, pp. 6398-6404.
3. E. Magdalena Nowara, T. K. Marks, H. Mansour, and A. Veeraraghavan, “Sparseppg: Towards driver monitoring using camera-based vital signs estimation in near-infrared,” in Proceedings of the IEEE conference on computer vision and pattern recognition workshops, 2018, pp. 1272-1281.
4. J. Kempfle and K. Van Laerhoven, “Respiration rate estimation with depth cameras: An evaluation of parameters,” in Proceedings of the 5th international Workshop on Sensor-based Activity Recognition and Interaction, 2018, pp. 1-10.
5. Y. Rong, S. Srinivas, H. Chu, H. Yu, K. Liu, and D. W. Bliss, “Respiration and cardiac activity sensing using 3-d cameras,” in 2020 54th Asilomar Conference on Signals, Systems, and Computers. IEEE, 2020, pp. 955-959.
6. V. C. Chen, F. Li, S.-S. Ho, and H. Wechsler, “Micro-doppler effect in radar: phenomenon, model, and simulation study,” IEEE Transactions on Aerospace and electronic systems, vol. 42, no. 1, pp. 2-21, 2006.
7. C. Li and J. Lin, “Random body movement cancellation in doppler radar vital sign detection,” IEEE Transactions on Microwave Theory and Techniques, vol. 56, no. 12, pp. 3143-3152, 2008.
8. Y. Rong and D. W. Bliss, “Harmonics-based multiple heartbeat detection at equal distance using uwb impulse radar,” in 2018 IEEE Radar Conference (RadarConf18). IEEE, 2018, pp. 1101-1105.
9. D. Bliss and K. Forsythe, “Multiple-input multiple-output (mimo) radar and imaging: degrees of freedom and resolution,” in The Thirty-Seventh Asilomar Conference on Signals, Systems & Computers, 2003, vol. 1. IEEE, 2003, pp. 54-59.
10. “Mimo radar medical imaging: self-interference mitigation for breast tumor detection,” in 2006 Fortieth Asilomar Conference on Signals, Systems and Computers. IEEE, 2006, pp. 1558-1562.
11. Y. Rong and D. W. Bliss, “Is radar cardiography (rcg) possible?” in 2019 IEEE Radar Conference (RadarConf). IEEE, 2019, pp. 1-6.
12. M. Nosrati, S. Shahsavari, S. Lee, H. Wang, and N. Tavassolian, “A con-current dual-beam phased-array doppler radar using mimo beamforming techniques for short-range vital-signs monitoring,” IEEE Transactions on Antennas and Propagation, vol. 67, no. 4, pp. 2390-2404, 2019.
13. C. Feng, X. Jiang, M.-G. Jeong, H. Hong, C.-H. Fu, X. Yang, E. Wang, X. Zhu, and X. Liu, “Multitarget vital signs measurement with chest motion imaging based on mimo radar,” IEEE Transactions on Microwave Theory and Techniques, vol. 69, no. 11, pp. 4735-4747, 2021.
14. A. Ahmad, J. C. Roh, D. Wang, and A. Dubey, “Vital signs monitoring of multiple people using a fmcw millimeter-wave sensor,” in 2018 IEEE Radar Conference (RadarConf18). IEEE, 2018, pp. 1450-1455.
15. Y. Rong, K. V. Mishra, and D. W. Bliss, “Radar-based radial arterial pulse rate and pulse pressure analysis,” in 2021 29th European Signal Processing Conference (EUSIPCO). IEEE, 2021, pp. 1870-1874.
16. Y. Rong, P. C. Theofanopoulos, G. C. Trichopoulos, and D. W. Bliss, “Cardiac sensing exploiting an ultra-wideband terahertz sensing system,” in 2020 IEEE International Radar Conference (RADAR). IEEE, 2020, pp. 1002-1006.
17. C. Gu, G. Wang, Y. Li, T. Inoue, and C. Li, “A hybrid radar-camera sensing system with phase compensation for random body movement cancellation in doppler vital sign detection,” IEEE transactions on microwave theory and techniques, vol. 61, no. 12, pp. 4678-4688, 2013.
18. D.-M. Chian, C.-K. Wen, C.-J. Wang, M.-H. Hsu, and F.-K. Wang, “Vital signs identification system with doppler radars and thermal camera,” IEEE Transactions on Biomedical Circuits and Systems, vol. 16, no. 1, pp. 153-167, 2022.
19. A. Shokouhmand, S. Eckstrom, B. Gholami, and N. Tavassolian, “Camera-augmented non-contact vital sign monitoring in real time,” IEEE Sensors Journal, 2022.
20. Z. Xu, C. Shi, T. Zhang, S. Li, Y. Yuan, C.-T. M. Wu, Y. Chen, and A. Petropulu, “Simultaneous monitoring of multiple people's vital sign leveraging a single phased-mimo radar,” IEEE Journal of Electromagnetics, RF and Microwaves in Medicine and Biology, 2022.
21. Y. Xiong, S. U, C. Gu, G. Meng, and Z. Peng, “Millimeter-wave bat for mapping and quantifying micromotions in full field of view,” Research, vol. 2021, 2021.
22. P. Turaga, R. Chellappa, V. S. Subrahmanian, and O. Udrea, “Machine recognition of human activities: A survey,” IEEE Transactions on Circuits and Systems for Video technology, vol. 18, no. 11, pp. 1473-1488, 2008.
23. N. Sarafianos, B. Boteanu, B. Ionescu, and I. A. Kakadiaris, “3d human pose estimation: A review of the literature and analysis of covariates,” Computer Vision and Image Understanding, vol. 152, pp. 1-20, 2016.
24. D. A. Noon, “Stepped-frequency radar design and signal processing enhances ground penetrating radar performance,” 1996.
25. Y. Rong, I. Lenz, and D. W. Bliss, “Vital Signs Detection based on High Resolution 3-D mmWave Radar Imaging,” in 2022 IEEE Phased Array Conference. IEEE, 2022, in press.
26. N. K. Nikolova, Introduction to microwave imaging. Cambridge University Press, 2017.
27. C. S. Bamji, S. Mehta, B. Thompson, T. Elkhatib, S. Wurster, O. Akkaya, A. Payne, J. Godbaz, M. Fenton, V. Rajasekaran et al., “Impixel 65 nm bsi 320 mhz demodulated tof image sensor with 3 μm global shutter pixels and analog binning,” in 2018 IEEE International Solid-State Circuits Conference-(ISSCC). IEEE, 2018, pp. 94-96.
28. Microsoft, Inc. (2020, February) Azure Kinect DK hardware specifications.[Online]. Available: https://docs.microsoft.com/en-us/azure/kinect-dk/hardware-specification.
29. Google, Inc, “MediaPipe Pose,” November 2022. [Online]. Available: https://google.github.io/mediapipe/solutions/pose.html
30. Y. Rong and D. W. Bliss, “Smart homes: See multiple heartbeats through wall using wireless signals,” in 2019 IEEE Radar Conference (RadarConf). IEEE, 2019, pp. 1-6.
31. K. Han and S. Hong, “Detection and localization of multiple humans based on curve length of i/q signal trajectory using mimo fmcw radar,” IEEE Microwave and Wireless Components Letters, vol. 31, no. 4, pp. 413-416, 2021.
32. M. Mercuri, P. Russo, M. Glassee, I. D. Castro, E. De Greef, M. Rykunov, M. Bauduin, A. Bourdoux, I. Ocket, F. Crupi et al., “Automatic radar-based 2-d localization exploiting vital signs signatures,” Scientific Reports, vol. 12, no. 1, pp. 1-11, 2022.
33. J. Yan, G. Zhang, H. Hong, H. Chu, C. Li, and X. Zhu, “Phase-based human target 2-d identification with a mobile fmcw radar platform,” IEEE Transactions on Microwave Theory and Techniques, vol. 67, no. 12, pp. 5348-5359, 2019.

1. A method for using a vision-guided radar beamforming system, the method comprising:
positionally fixing, with a support structure, an array of radar transmitters, an array of radar receivers, and at least one optical camera configured to provide depth information to provide a camera-radar dual sensing apparatus;
sequentially placing a corner reflector at a plurality of positions within a field of view (FOV) of the camera-radar dual sensing apparatus;
operating the array of radar transmitters, the array of radar receivers, and the at least one optical camera while the corner reflector is placed at each of the plurality of positions within the FOV;
collecting, with the array of radar receivers, radar coordinates corresponding to a peak locations of an energy cluster of radar energy reflected by the corner reflector, while the corner reflector is placed at each of the plurality of positions within the FOV;
collecting, with the at least one camera, visual coordinates of a reflective center of the corner reflector, while the corner reflector is placed at each of the plurality of positions within the FOV;
utilizing a computing device employing the collected radar coordinates and the collected visual coordinates, to generate a transformation function that maps visual coordinates to radar coordinates within the FOV of the camera-radar dual sensing apparatus; and
operating the camera-radar dual sensing apparatus to (i) detect presence of multiple human subjects in the FOV, and (ii) detect vital signs of the multiple human subjects in the FOV.

2. The method of claim 1, wherein the transformation function comprises an affine transformation with twelve degrees of freedom that incorporate three-dimensional translation and rotation.

3. The method of claim 2, further comprising constructing radar beamforming weights utilizing coefficients of the affine transformation.

4. (canceled)

5. The method of claim 1, wherein the vital signs comprise at least one of respiration rate and heart rate.

6. The method of claim 1, wherein the at least one optical camera comprises a plurality of optical cameras.

7. The method of claim 1, wherein the array of radar transmitters comprises a linear array of radar transmitters, the array of radar receivers comprises a linear array of radar receivers, and the linear array of radar transmitters is arranged orthogonal to the linear array of radar receivers.

8. A vision-guided radar system comprising:
a camera-radar dual sensing apparatus including an array of radar transmitters, an array of radar receivers, and at least one optical camera configured to provide depth information; and
a memory containing a transformation function that maps visual coordinates to radar coordinates within a field of view (FOV) of the camera-radar dual sensing apparatus;
wherein the camera-radar dual sensing apparatus is configured to utilize the transformation function for vision-guided radar beamforming in use of the camera-radar dual sensing apparatus; and
wherein the camera-radar dual sensing apparatus is further configured to: (i) detect presence of multiple human subjects in the FOV, and (ii) detect vital signs of the multiple human subjects in the FOV.

9. The vision-guided radar system of claim 8, further comprising a support structure that positionally fixes the array of radar transmitters, the array of radar receivers, and the at least one optical camera relative to one another.

10. The vision-guided radar system of claim 8, further comprising a computing device configured to employ collected radar coordinates and collected visual coordinates to generate the transformation function.

11. The vision-guided radar system of claim 10, wherein:
the collected radar coordinates are obtained by collecting, with the array of radar receivers, radar coordinates corresponding to a peak locations of an energy cluster of radar energy reflected by a corner reflector, while the corner reflector is sequentially placed at each of a plurality of positions within the FOV; and
the collected visual coordinates are obtained by collecting, with the at least one camera, visual coordinates of a reflective center of the corner reflector, while the corner reflector is sequentially placed at each of the plurality of positions within the FOV.

12. The vision-guided radar system of claim 8, wherein the transformation function comprises an affine transformation with twelve degrees of freedom that incorporate three-dimensional translation and rotation.

13. The vision-guided radar system of claim 12, wherein the utilization of the transformation function comprises utilization of coefficients of the affine transformation.

14. (canceled)

15. The vision-guided radar system of claim 8, wherein the vital signs comprise at least one of respiration rate and heart rate.

16. The vision-guided radar system of claim 8, wherein the at least one optical camera comprises a plurality of optical cameras.

17. The vision-guided radar system of claim 8, wherein the at least one optical camera comprises an RGB camera and a depth sensor.

18. The vision-guided radar system of claim 8, wherein the array of radar transmitters comprises a linear array of radar transmitters, the array of radar receivers comprises a linear array of radar receivers, and the linear array of radar transmitters is arranged orthogonal to the linear array of radar receivers.
